(19) United States
(12) Patent Application Publication
(10) Pub. No.: US 2021/0219573 A1
(43) Pub. Date: Jul. 22, 2021

(54) CANNABOSIDE COMPOSITION AND METHOD TO PRODUCE

(71) Applicant: Cannabis Global, Inc., Los Angeles, CA (US)

(72) Inventor: Joseph Noel, Seal Beach, CA (US)

(21) Appl. No.: 17/151,607

(22) Filed: Jan. 18, 2021

Related U.S. Application Data
(60) Provisional application No. 62/962,040, filed on Jan. 16, 2020.

(51) Int. Cl. A23K 20/121; A23K 10/20; A23L 2/52; A23F 3/00; A23F 5/00; A23L 29/00

(52) U.S. Cl. CPC A23K 20/121; A23K 10/20; A23L 2/52; A23K 50/90; A23F 5/00; A23L 29/035; A23F 3/00

(57) ABSTRACT

A composition comprising one or more cannabosides, cannabinoid metabolites, or a combination thereof produced by an animal which has been fed a feedstock comprising one or more cannabinoids. A method to produce the compositions and articles comprising the composition are also disclosed.

### RELATED APPLICATIONS

This application claims the benefit of a U.S. Provisional Application Ser. No. 62/962,040 filed Jan. 16, 2020, the disclosure of which is incorporated by reference herein in its entirety.

### FIELD OF THE INVENTION

This invention relates to a composition comprising one or more cannabosides and a method of producing one or more cannabosides. In particular, by feeding an insect a cannabinoid and harvesting the insect.

### BACKGROUND OF THE INVENTION

Delivery of biologically active compounds such as pharmaceuticals and so-called nutraceuticals to living systems is the object of much study and research. Making a material available to a living system may be further complicated by the solubility profile of the material. While technologies exist that may render a material with low water solubility available to a living system, such technologies typically have other drawbacks rendering their use limited to particular instances.

One attractive means of delivering biologically active material to living organisms, such as human beings, is via an ingestible carrier, preferably one consumed and enjoyed by the population at large. However, this is problematic when the biologically active material has limited water solubility and/or is imparts an unpleasant taste to the ingestible carrier. There is a need in the art for compositions having biologically active components which are suitable for use in a foodstuffs consumed by humans. There is also a need to produce these compositions in an environmentally responsible way.

### SUMMARY OF THE INVENTION

In one aspect, a composition comprises one or more cannabosides, cannabinoid metabolites, or a combination thereof produced by an animal which has been fed a feedstock comprising one or more cannabinoids.

In another aspect, a method comprises the steps of feeding an animal a feedstock comprising one or more cannabinoids; harvesting the animal; and freeze-drying, lyophilizing, dehydrating, and/or masticating at least a portion of the animal to produce a composition comprising one or more cannabosides, cannabinoid metabolites, or a combination thereof produced by the animal.

In one aspect, an article comprises a formulation for human ingestion comprising one or more cannabosides, cannabinoid metabolites, or a combination thereof comprising at least a portion of and/or an extract of an animal which has been fed a feedstock comprising one or more cannabinoids.

### DETAILED DESCRIPTION OF THE INVENTION

For the purposes of this invention and the claims thereto, the new numbering scheme for the Periodic Table Groups is used as described in CHEMICAL AND ENGINEERING NEWS, 63(5), p. 27 (1985). Therefore, a “Group 4 metal” is an element from Group 4 of the Periodic Table.

For purposes of this invention and claims thereto, the term “substituted” means that a hydrogen group has been replaced with a hydrocarbyl group, a heteroatom, or a heteroatom containing group. For example, a “substituted hydrocarbyl” is a radical made of carbon and hydrogen where at least one hydrogen is replaced by an alkyl group, a heteroatom or heteroatom containing group. The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

Unless otherwise indicated, (e.g., the definition of “substituted hydrocarbyl”, “substituted cannabinol,” etc.), the term “substituted” means that at least one hydrogen atom has been replaced with at least one non-hydrogen group, such as a hydrocarbyl group, a heteroatom, or a heteroatom containing group, or at least one functional group such as a halogen (e.g., Br, Cl, F, I), —NR*₂, —NR*—CO—R*, —OR*, *—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —GeR*₃, —SnR*₃, —PbR*₃, —(CH₂)q-SiR*₃, or a combination thereof, wherein q is 1 to 10 and each R* is independently hydrogen, a C₁-C₁₀ alkyl radical, and/or two or more R* may join together to form a substituted or unsubstituted completely saturated, partially unsaturated, or aromatic cyclic or polycyclic ring structure.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —NR*—CO—R*, —OR*, *—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —GeR*₃, —SnR*₃, —PbR*₃, —(CH₂)q-SiR*₃, or a combination thereof, wherein q is 1 to 10 and each R* is independently hydrogen, a C₁-C₁₀ alkyl radical, and/or two or more R* may join together to form a substituted or unsubstituted completely saturated, partially unsaturated, or aromatic cyclic or polycyclic ring structure.

Other examples of functional groups include those typically referred to as amines, imides, amides, ethers, alcohols (hydroxides), sulfides, sulfates, phosphides, halides, phosphonates, alkoxides, esters, carboxylates, aldehydes, glucosides, glucuronides, and the like.

Unless otherwise indicated, room temperature is 25° C. “Different” or “not the same” as used to refer to R groups in any formula herein (e.g., R² and R⁸ or R⁴ and R¹⁰) or any substituent herein indicates that the groups or substituents differ from each other by at least one atom or are different isomerically.

Unless otherwise noted, all molecular weights are reported in units of g/mol or Daltons (Da). The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, Bn is benzyl, CBD refers to cannabidiol, THC refers to tetrahydrocannabinol, TPGS refers to tocopheryl polyalkylene glycol succinates and derivatives thereof, HPMC refers to hydroxypropyl methylcellulose and derivatives thereof, and the like.

For purposes herein, the terms “group,” “radical,” and “substituent” may be used interchangeably. A multivalent radical refers to a radical having two or more attachment points, e.g., methylene —CH₂— is a multivalent radical of methane.

Unless indicated otherwise, as used herein, a water soluble composition is defined as a composition in which 1 g of the composition dissolves, (i.e., forms a clear solution) in 100 mls of water at a temperature of 25° C. with stirring within 30 seconds.

Unless indicated otherwise, as used herein, a water miscible composition is defined as a composition in which 1 g of the composition disperses (i.e., forms a clear to turbid solution) in 100 mls of water at a temperature of 25° C. with stirring within 30 seconds, and in which at least 95 wt % of the composition remains dispersed in the mixture after 5 minutes without stirring.

As used herein, “colloid” refers to a mixture containing two phases, a dispersed phase and a continuous phase, with the dispersed phase containing particles (droplets) distributed throughout the continuous phase. Colloidal mixtures include aerosols, foams, and dispersions.

For purposes herein, a free-flowing solid, which may include a powder, refers to a composition in which the particles are cohesive and do not cling to one another to an extent which prevents the solid from flowing through sieve having 1 cm square opening. Dry sand is an example of a free-flowing solid. Accordingly, free flowing powders have a positive angle of repose.

As used herein, “surfactant” refers to synthetic and naturally occurring amphiphilic molecules that have hydrophobic portion(s) and hydrophilic portion(s). A “surfactant system” refers to combinations and/or blends or mixtures of surfactants to produce an intended characteristic. Examples of surfactant systems include so-called “matched pairs” of surfactants having different hydrophobe/lipophobe balance (HLB) characteristics.

As used herein, “HLB” refers to a value that is used to index and describe a surfactant according to its relative hydrophobicity/hydrophilicity, relative to other surfactants. A surfactant's HLB value is an indication of the molecular balance of the hydrophobic and hydrophilic portions of the surfactant, which is an amphipathic molecule. Each surfactant and mixture of surfactants (and/or co-surfactants) has an HLB value that is a numerical representation of the relative weight percent of hydrophobic and hydrophilic portions of the surfactant molecule(s). HLB values are derived from a semi-empirical formula. The relative weight percentages of the hydrophobic and hydrophilic groups are indicative of surfactant properties, including the molecular structure, for example, the types of aggregates the surfactants form and the solubility of the surfactant. See, for example, Griffin (1949) J. Soc. Cos. Chem. 1:311. Surfactant HLB values range from 1-45, while the range for non-ionic surfactants typically is from 1-20. The more lipophilic a surfactant is, the lower its HLB value. Conversely, the more hydrophilic a surfactant is, the higher its HLB value.

Due to their amphiphilic (amphipathic) nature, surfactants typically can reduce the surface tension between two immiscible liquids, for example, the oil and water phases in an emulsion, stabilizing the emulsion. Surfactants may be characterized herein based on their relative hydrophobicity and/or hydrophilicity. For example, relatively lipophilic surfactants are more soluble in fats, oils and waxes, and typically have HLB values less than or about 10, while relatively hydrophilic surfactants are more soluble in aqueous compositions, for example, water, and typically have HLB values greater than or about 10. Relatively amphiphilic surfactants are soluble in oil- and water-based liquids and typically have HLB values close to 10 or about 10.

As used herein, “co-surfactant” is used to refer to a surfactant that is used in the provided compositions in combination with the primary surfactant, for example, the composition described herein, for example, to improve the emulsification of the provided compositions and/or compounds, for example, to emulsify the ingredients upon dilution. In one example, the provided compositions can contain at least one surfactant and at least one co-surfactant. Typically, the co-surfactant represents a lower percent, by weight of the provided compositions, compared to the surfactant. Thus, the provided compositions typically have a lower concentration of the co-surfactant(s) than of the surfactant.

As used herein, “micelle” refers to aggregates formed by surfactants that typically form when a surfactant is present in an aqueous composition, typically when the surfactant is used at a concentration above the critical micelle concentration (CMC). In micelles, the hydrophilic portions of the surfactant molecules contact the aqueous or the water phase, while the hydrophobic portions form the core of the micelle, which can encapsulate the non-polar cannabinoids and other ingredient(s). Typically, the surfactants form micelles containing the cannabinoids within either as the particles are formed, upon dilution of aspects of the composition or the mixture produced by dilution thereof in water, or both. Typically, the micelles in aspects of the composition or the mixture produced by dilution thereof have an average particle size of less than or equal to about 1000 nm, typically less than or less than about 500 nm, typically less than 300 or less than about 300 nm, for example, less than 250 nm or less than about 250 nm, for example, less than 200 nm or less than about 200 nm, for example, less than or less than about 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 110, 120, 130, 140, 150, 160, 170, 180, 190, or 200 nm.

As used herein, “analog” and/or “derivative” refers to a chemical compound that is structurally similar to another compound (referred to as a parent compound), but differs slightly in composition, for example, due to the variation, addition or removal of an atom, one or more units (e.g., methylene units, —(CH₂)ₙ—) or one or more functional groups, e.g., a glycoside of a phenolic compound is a phenolic ether analog and/or derivative of the phenolic parent compound. The analog and/or derivative can have different chemical or physical properties compared with the original compound and/or can have improved biological and/or chemical activity. Alternatively, the analog and/or derivative can have similar or identical chemical or physical properties compared with the original compound and/or can have similar or identical biological and/or chemical activity. For example, the analog and/or derivative can be more hydrophilic, or it can have altered reactivity as compared to the parent compound. The analog and/or derivative can mimic the chemical and/or biological activity of the parent compound (i.e., it can have similar or identical activity), or, in some cases, can have increased or decreased activity. The analog and/or derivative can be a naturally or non-naturally occurring (e.g., synthetic) variant of the original compound. Other types of analogs and/or derivatives include isomers (e.g., enantiomers, diastereomers) and other types of chiral variants of a compound, as well as structural isomers. The analog and/or derivative can be a branched or cyclic variant of a linear compound. For example, a linear compound can have an analog and/or derivative that is branched or otherwise substituted, e.g., a saccharide, a glucoside, a glucuronide, and/or the like, to impart certain advantageous properties (e.g., improved hydrophobicity or bioavailability).

As used herein, “organoleptic properties” refers to sensory attributes of a food or beverage, in particular upon dilution of the composition into a beverage. Those of skill in the art understand such properties and they can be quantitated if needed. Organoleptic properties include, but are not limited to, taste, odor and/or appearance. “Desirable” or “advantageous” organoleptic properties include those organoleptic properties of a food or beverage composition for consumption by an average human subject, such as a desirable odor, taste and/or appearance, or the lack of an undesirable odor, taste and/or appearance. Undesirable organoleptic properties include the presence of, for example, an undesirable taste, odor or appearance attribute, such as the presence of an “off-taste” or “off-odor,” for example a fishy, grassy, metal or iron, sharp or tingling taste or odor, or the presence of an undesirable appearance attribute, such as separation or precipitation. In one example, the provided beverage compositions retain the same or about the same taste, odor and/or appearance as the same beverage composition that does not contain the composition according to aspects disclosed herein. As such, dilution of a composition according to one or more aspects disclosed herein results in a beverage or other consumable material which retains organoleptic properties desirable for consumption by an average human subject. Desirable and undesirable organoleptic properties can be measured by a variety of methods known to those skilled in the art, including, for example, organoleptic evaluation methods by which undesirable properties are detectable by sight, taste and/or smell and chemical tests, as well as by chemical analytical methods. As used herein, “retaining the organoleptic properties” refers to retention of these properties upon storage for a recited period of time, typically at room temperature.

As used herein, “visible particles” are particles, for example, in a liquid, such as an emulsion, that are visible when viewing the liquid with the naked eye (i.e., without magnification). For example, the visible particles can be particles that are observed by the artisan formulating aspects of the composition or the mixture produced by dilution thereof. In one example, the dilution of the composition contain no visible particles. In another example, the diluted compositions contain few visible particles, for example, no more visible particles than another liquid, for example, a beverage. The presence of visible particles and the number of visible particles is determined by empirical observation.

As used herein, “clear” can be used to describe the resultant mixture upon dilution of the compositions provided herein.

As used herein, “stability” refers to a desirable property of the provided composition. For example, the ability of the provided composition to remain free from one or more changes over a period of time, for example, at least or longer than 1 day, 1 week, 1 month, 1 year, or more. For example, a composition is described as stable if it is formulated such that it remains in its initial form (e.g., as a tablet) and/or free from oxidation or substantial oxidation over time, and/or desirable for human consumption over time, has a lack of precipitates forming over time, does not exhibit any visible phase separation and/or significant changes in appearance over a period of time.

As used herein, “stabilize” means to increase the stability of one of the provided compositions.

As used herein, “hydrophilic” and “polar” refer synonymously to ingredients and/or compounds having greater solubility in aqueous liquids, for example, water, than in fats, oils and/or organic solvents (e.g., methanol, ethanol, ethyl ether, acetone and benzene).

As used herein, a “solvent” is an ingredient that can be used to dissolve another ingredient. Solvents include polar and non-polar solvents. Non-polar solvents include oils and other non-polar ingredients that dissolve non-polar compounds. Typically, the non-polar solvent included in aspects of the composition or the mixture produced by dilution thereof is an oil. The non-polar solvent typically is not the non-polar ingredient itself, i.e., is distinct from the cannabinoid. More than one non-polar solvent can be used. Certain compounds, for example, flaxseed oil and safflower oil, can be non-polar solvents and non-polar ingredients. Typically, the non-polar solvent contains one or more oils, typically oils other than the non-polar ingredient or oil(s) not contained in the non-polar ingredient. Exemplary non-polar solvents include, but are not limited to, oils (in addition to the non-polar ingredient), for example, tocopheryl polyalkylene glycol oil, flaxseed oil, CLA, borage oil, rice bran oil, D-limonene, canola oil, corn oil, MCT oil and oat oil. Other oils also can be used.

As used herein, “polar solvent” refers to a solvent that is readily miscible with water and other polar solvents. Polar solvents are well-known and can be assessed by measuring any parameter known to those of skill in the art, including dielectric constant, polarity index and dipole moment (see, e.g., Przybitek (1980) “High Purity Solvent Guide,” Burdick and Jackson Laboratories, Inc.). For example, polar solvents generally have high dielectric constants, such as greater than or about 15, generally have high polarity indices, typically greater than or about 3, and generally large dipole moments, for example, greater than or about 1.4 Debye. Polar solvents include polar protic solvents and polar aprotic solvents.

As used herein, a “polar protic solvent” is a polar solvent containing a hydrogen atom attached to an electronegative atom, such that the hydrogen has a proton-like character and/or the bond between the hydrogen and electronegative atom is polarized. Exemplary polar protic solvents include, but are not limited to, water, alcohols, including monohydric, dihydric and trihydric alcohols, including, but not limited to, methanol, ethanol, glycerin and propylene glycol.

As used herein, “monohydric alcohols” are alcohols that contain a single hydroxyl group including, but not limited to, methanol, ethanol, propanol, isopropanol, n-butanol and t-butanol.

As used herein, “dihydric alcohols” are alcohols that contain two hydroxyl groups. Exemplary dihydric alcohols include, but are not limited to, glycols, e.g., propylene glycol, ethylene glycol, tetraethylene glycol, triethylene glycol and trimethylene glycol.

As used herein, “trihydric alcohols” are alcohols that contain three hydroxyl groups. Exemplary trihydric alcohols include, but are not limited to, glycerin, butane-1,2,3-triol, pentane-1,3,5-triol and 2-amino-2-hydroxymethyl-propane-1,3-diol.

As used herein, “non-polar,” “lipophilic” and “lipid-soluble” synonymously refer to compounds and/or ingredients, for example, non-polar compounds and non-polar ingredients, which have greater solubility in organic solvents (e.g., ethanol, methanol, ethyl ether, acetone and benzene), fats and oils than in aqueous liquids, for example, water. Non-polar ingredients include drugs, hormones, vitamins, nutrients and other lipophilic compounds. Typically, non-polar ingredients are poorly water-soluble, for example, water insoluble or compounds having low water solubility. Exemplary non-polar ingredients include ingredients that contain one or more non-polar compounds, for example, lipid-soluble drugs, hormones, essential fatty acids, for example, polyunsaturated fatty acids (PUFA), for example, omega-3 and omega-6 fatty acids, vitamins, nutrients, nutraceuticals, minerals and other compounds. Additional exemplary non-polar ingredients are described herein. The provided compositions can be formulated with any non-polar ingredient, for example, any non-polar ingredient that is or contains a non-polar compound.

As used herein, an “additive” includes anything other than cannabinoids that one can add to a food, beverage, or other human consumable to enhance one or more of its nutritional, pharmaceutical, dietary, health, nutraceutical, health benefit, energy-providing, treating, holistic, or other properties. For example, the additives can be oil-based additives (e.g., non-polar ingredients), such as nutraceuticals; pharmaceuticals; vitamins, for example, oil-soluble vitamins, e.g., vitamin D, tocopheryl polyalkylene glycol and vitamin A; minerals; fatty acids, such as essential fatty acids, for example, polyunsaturated fatty acids, e.g., omega-3 fatty acids and omega-6 fatty acids, such as alpha-linolenic acid (ALA), docosahexaenoic acid (DHA), eicosapentaenoic acid (EPA), gamma-linolenic acid (GLA), CLA, saw palmetto extract, flaxseed oil, fish oil and algae oil, phytosterols; coenzymes, such as coenzyme Q10; and any other oil-based additives.

As used herein, “low water solubility” refers to a compound that has a solubility in water of less than or about 30 mg/mL, for example, when mixed with water at room temperature, such as between or between about 25° C. and 50° C. As used herein, “poorly water-soluble”can be used to refer to compounds, for example, non-polar compounds, that are water insoluble or have low water solubility.

As used herein, “foodstuff” and/or “food and beverage product” refers to a product that is suitable for human consumption. For example, “foodstuff” can refer to a composition that is dissolved in a solvent, typically an aqueous solvent, e.g., water, to form a liquid dilution composition, i.e., beverage composition or beverage product. “Foodstuff” can also refer to an ingredient used in food, e.g., a flour or additive, to produce the final product that is suitable for human consumption.

As used herein, a “beverage base” refers to an aqueous composition to which one or more non-polar ingredients can be added. A beverage base includes, but is not limited to, an aqueous composition that contains one or more of a polar solvent, typically water, a juice, such as a fruit juice, a fruit juice concentrate, a fruit juice extract, a fruit flavor, a soda, a flavored soda, a carbonated water, a carbonated juice and any combination thereof. Aspects of the composition can be introduced into a beverage base (or beverage or other food).

As used herein, a “fruit juice,” “fruit juice concentrate,” “fruit juice extract” or “fruit flavor” refer to fruit-based juices and flavors that impart taste or smell to the provided beverage compositions (products). Any juice or fruit flavor can be added to the provided beverage compositions, including, but not limited to, plum, prune, date, currant, fig, grape, raisin, cranberry, pineapple, peach, nectarine, banana, apple, pear, guava, apricot, Saskatoon berry, blueberry, plains berry, prairie berry, mulberry, elderberry, Barbados cherry (acerola cherry), choke cherry, chocolate, vanilla, caramel, coconut, olive, raspberry, strawberry, huckleberry, loganberry, dewberry, boysenberry, kiwi, cherry, blackberry, honey dew, green tea, cucumber, quince, buckthorn, passion fruit, sloe, rowan, gooseberry, pomegranate, persimmon, mango, rhubarb, papaya, litchi, lemon, orange, lime, tangerine, mandarin and grapefruit juices, or any combination thereof. Exemplary beverage compositions provided herein include combinations of juices or flavors that impart peach mango, peach, citrus, pomegranate blueberry, tropical berry, cherry chocolate, vanilla, cherry vanilla, chocolate blueberry, chocolate caramel, cucumber, green tea, honey-dew melon, pineapple papaya, peach nectarine, raspberry lemonade, grape, orange tangerine, orange, lime and mixed berry flavors.

As used herein, “fatty acid” refers to straight-chain hydrocarbon molecules with a carboxyl (—COOH) group at one end of the chain.

As used herein, “polyunsaturated fatty acid” and “PUFA” are used synonymously to refer to fatty acids that contain more than one carbon-carbon double bonds in the carbon chain of the fatty acid. PUFAs, particularly essential fatty acids, are useful as dietary supplements.

Examples include omega-3 fatty acids such as alpha-linolenic acid (alpha-linolenic acid; ALA) (18:3omega3) (a short-chain fatty acid); stearidonic acid (18:4omega3) (a short-chain fatty acid); eicosapentaenoic acid (EPA) (20:5omega3); docosahexaenoic acid (DHA) (22:6omega3); eicosatetraenoic acid (24:4omega3); docosapentaenoic acid (DPA, clupanodonic acid) (22:5omega3); 16:3 omega3; 24:5 omega3 and nisinic acid (24:6omega3). Longer chain omega-3 fatty acids can be synthesized from ALA (the short-chain omega-3 fatty acid). Exemplary of non-polar ingredients containing omega-3 fatty acids are non-polar ingredients containing DHA and/or EPA, for example, containing fish oil, krill oil and/or algae oil, for example, microalgae oil, and non-polar ingredients containing alpha-linolenic acid (ALA), for example, containing flaxseed oil. Other exemplary fatty acids include linoleic acid (18:2omega6) (a short-chain fatty acid); gamma-linolenic acid (GLA) (18:3omega6); dihomo gamma linolenic acid (DGLA) (20:3omega6); eicosadienoic acid (20:2omega6); arachidonic acid (AA) (20:4omega6); docosadienoic acid (22:2omega6); adrenic acid (22:4omega6); and docosapentaenoic acid (22:5omega6). Exemplary of non-polar ingredients containing omega-6 fatty acids are ingredients containing GLA, for example, borage oil. Also exemplary of omega-6-containing non-polar ingredients are compounds containing conjugated fatty acids, for example, conjugated linoleic acid (CLA) and compounds containing saw palmetto extract.

As used herein, “preservative” and “preservativer” are used synonymously to refer to ingredients that can improve the stability of aspects of the composition and/or the liquid produced by dilution of the composition. Preservatives, particularly food and beverage preservatives, are well known. Any known preservative can be used in aspects of the composition and/or the liquid produced by dilution of the composition. Exemplary of the preservatives include benzyl alcohol, benzyl benzoate, methyl paraben, propyl paraben, antioxidants, for example, vitamin E, vitamin A palmitate and beta carotene. Typically, a preservative is selected that is safe for human consumption, for example, in foods and beverages, for example, a GRAS certified and/or Kosher-certified preservative, for example, benzyl alcohol.

As used herein, an “antioxidant” refers to a stabilizer or one component of a stabilizing system that acts as an antioxidant, and that, when aspects of the composition are added to a beverage composition in combination with the other required components (i.e., acid and/or bicarbonate or carbonate) yields beverage compositions that retain one or more desired organoleptic properties, such as, but not limited to, the taste, smell, odor and/or appearance, of the beverage composition over time. Typically, antioxidants are food-approved, e.g., edible antioxidants, for example, antioxidants that are safe and/or approved for human consumption. Exemplary antioxidants include, but are not limited to, ascorbic acid, vitamin C, ascorbate and coenzyme Q-containing compounds, including, but not limited to, coenzyme Q10.

As used herein, an “acid” or “ingestible acid” refers to a stabilizer or one component of a stabilizing system that, when added to a beverage composition in combination with the other components (i.e., antioxidant and/or bicarbonate or carbonate), yields compositions that retain one or more desired organoleptic properties, such as, but not limited to, the taste, smell, odor and/or appearance of the composition over time. Typically, the acids are food-approved, e.g., edible acids or ingestible acids, for example, acids that are safe and/or approved for human consumption. Exemplary acids include, but are not limited to, citric acid, phosphoric acid, adipic acid, ascorbic acid, lactic acid, malic acid, fumaric acid, gluconic acid, succinic acid, tartaric acid and maleic acid.

As used herein, a “bicarbonate” or “carbonate” refers to a stabilizer or one component of a stabilizing system that, when added to a beverage composition in combination with the other components (i.e., the acid and/or antioxidant) yields compositions that retain one or more desired organoleptic properties, such as, but not limited to, the taste, smell, odor and/or appearance of the composition over time. Typically, bicarbonates or carbonates are food-approved, e.g., edible bicarbonates or carbonates, for example, bicarbonates or carbonates that are safe and/or approved for human consumption. Exemplary bicarbonates include, but are not limited to, potassium bicarbonate and sodium bicarbonate. Exemplary carbonates include, but are not limited to, potassium carbonate, sodium carbonate, calcium carbonate, magnesium carbonate and zinc carbonate.

As used herein, “emulsion stabilizer” refers to compounds that can be used to stabilize and/or emulsify and/or change the viscosity of aspects of the composition and/or the liquid produced by dilution of the composition. For example, the emulsion stabilizer can increase the viscosity of the liquid produced by dilution of the composition. One or more emulsion stabilizers can be used. Addition of an emulsion stabilizer can prevent separation of the composition and/or the liquid produced by dilution of the composition.

As used herein, a “pH adjuster” is any compound, typically an acid or a base, that is capable of changing the pH of aspects of the composition or the mixture produced by dilution thereof, for example, to reduce the pH of the composition and/or the liquid produced by dilution of the composition, or to increase the pH of the same, typically without altering other properties of the composition and/or the liquid produced by dilution of the composition, or without substantially altering other properties. pH adjusters are well known. Exemplary of the pH adjusters are acids, for example, citric acid and phosphoric acid, and bases.

As used herein, “flavor” is any ingredient that changes, typically improves, the taste and/or smell of aspects of the composition and/or the liquid produced by dilution of the composition, for example, in a beverage.

As used herein, “natural” is used to refer to a composition, and/or ingredients in aspects of the composition and/or the liquid produced by dilution of the composition, that can be found in nature and is not solely man-made. For example, benzyl alcohol is a natural preservative. Similarly, tocopheryl polyethylene glycol is a natural surfactant. The natural composition/ingredient can be GRAS and/or Kosher-certified.

As used herein, “G.R.A.S.” and “GRAS” are used synonymously to refer to compounds, compositions and ingredients that are “Generally Regarded as Safe” by the USDA and FDA for use as additives, for example, in foods, beverages and/or other substance for human consumption, such as any substance that meets the criteria of sections 201(s) and 409 of the U.S. Federal Food, Drug and Cosmetic Act. Typically, aspects of the composition and/or the liquid produced by dilution of the composition disclosed herein are GRAS certified. Likewise, “kosher” is used to refer to substances that conform to Jewish Kosher dietary laws, for example, substances that do not contain ingredients derived from non-kosher animals or do not contain ingredients that were not made following kosher procedures. Typically, aspects of the composition and/or the liquid produced by dilution of the composition are Kosher-certified.

As used herein, “excipients”, refer to any substance needed to formulate the composition to a desired form. For example, suitable excipients include but are not limited to, diluents or fillers, binders or granulating agents or adhesives, disintegrates, lubricants, antiadherants, glidants, wetting agents, dissolution retardants or enhancers, adsorbents, buffers, chelating agents, preservatives, colors, flavors and sweeteners. Typical excipients include, but are not limited to, starch, pregelatinized starch, maltodextrin, monohydrous dextrose, alginic acid, sorbitol and mannitol. In general, the excipient should be selected from non-toxic excipients (JIG, Inactive Ingredient Guide, or GRAS, Generally Regarded as safe, Handbook of Pharmaceutical Excipients).

As used herein, a binder is an excipient added to a composition to aid formation of a powder when the composition is dried. Non-limiting examples of suitable binders include, but are not limited to, acacia, dextrin, starch, povidone, carboxymethylcellulose, guar gum, glucose, hydroxypropyl methylcellulose, methylcellulose, polymethacrylates, maltodextrin, hydroxyethyl cellulose, whey, disaccharides, sucrose, lactose, polysaccharides and their derivatives such as starches, cellulose or modified cellulose such as microcrystalline cellulose and cellulose ethers such as hydroxypropyl cellulose, sugar alcohols such as xylitol, sorbitol or maltitol, protein, gelatins and synthetic polymers, such as polyvinylpyrrolidone (PVP) or polyethylene glycol (PEG).

As used herein, “homolog” refers to an analog that differs from the parent compound only by the presence or absence of a simple unit, such as a methylene unit, or some multiple of such units, e.g., —(CH₂)ₙ—. Typically, a homolog has similar chemical and physical properties as the parent compound. Exemplary of the homologs used in the provided compositions and methods are TPGS homologs.

As used herein a formulation for human ingestion (or consumption), according to aspects disclosed herein refers to a carrier that is compatible with other ingredients in the composition and that is not harmful or deleterious to the subject. The formulation may include various solids and/or liquids. Furthermore, components suitable for human ingestion include one or more “pharmaceutically acceptable” components such as a salt, a carrier, an excipient, a diluent, and the like, which is compatible with the other ingredients of the composition in that the component can be combined with the compositions of the present invention without rendering the composition unsuitable for its intended purpose, and is suitable for use with subjects as provided herein without undue adverse side effects (such as toxicity, irritation, and allergic response). Side effects are “undue” when their risk outweighs the benefit provided by the composition. Non-limiting examples of pharmaceutically acceptable components include any of the standard pharmaceutical carriers such as phosphate buffered saline solutions, water, emulsions such as oil/water emulsion, microemulsions and various types of wetting agents which are generally regarded as safe.

As used herein, a biocompatible, biodegradable polymer is a polymer which can be broken down in vivo to monomer and/or oligomer fragments, wherein the monomeric or oligomeric fragments do not provoke an immune response, are not toxic, and can be easily excreted.

A used herein, a cannabosides and/or a cannabinoid metabolite includes cannabinoids which have been further substituted with one or more carbohydrates, e.g., sugars or other conjugates, e.g., glutathione conjugates, during metabolism of the cannabinoid by an animal. The process takes place withing the living animal but is not necessarily derived from metabolism in the gut of the animal, and may occur by any natural process of the animal. Cannabosides include cannabinoid glycosides and the like.

In one aspect, a composition, comprises one or more cannabosides, cannabinoid metabolites, or a combination thereof produced by an animal which has been fed a feedstock comprising one or more cannabinoids. In an aspect, the composition comprises at least a portion of the animal which has been fed the feedstock comprising one or more cannabinoids. For example the composition may include at least a portion of a cricket that has been fed a feedstock comprising one or more cannabinoids. In aspects, the composition comprises at least a portion of the animal that has been freeze-dried, lyophilized, dehydrated, masticated, or a combination thereof.

In aspects of the composition, the one or more cannabosides, cannabinoid metabolites, or a combination thereof present in the composition are produced by extracting at least a portion of the animal which has been fed a feedstock comprising one or more cannabinoids, with a solvent.

In one such aspect, the one or more cannabosides and/or cannabinoid metabolites present in the composition are produced by feeding the animal a feedstock comprising one or more cannabinoids; harvesting the animal; and freeze-drying, lyophilizing, dehydrating, and/or masticating at least a portion of the animal to produce a composition comprising one or more cannabosides, cannabinoid metabolites, or a combination thereof produced by the animal, followed by contacting at least a portion of the harvested animal with a solvent to produce a mixture; filtering the mixture, and collecting the solvent to produce an extract comprising the one or more cannabosides, cannabinoid metabolites, or a combination thereof. In one or more aspects, at least a portion of the solvent is removed from the extract.

In one or more aspects, the animal is an insect. However, this is subject to the proviso that the animal is not a bee i.e., belonging to the Apidae family. Furthermore, it is to be understood that the composition is not honey. In one aspect, the animal belongs to the Orthoptera order, preferably to the Ensifera suborder or subfamily, the Gryllidea infraorder, and the Grylloidea superfamily, i.e., Gryllidae. In other aspects, the animal belongs to the Schizodactylidae superfamily. In other aspects, the animal belongs to the Tettigonioidea suborder. In other aspects, the animal belongs to the Caelifera suborder or subfamily.

In one or more aspects, the composition is in the form of a free-flowing solid.

In one or more aspects, the composition comprises less than or equal to about 0.1 wt % Δ9-tetrahydrocannabinol.

In one or more aspects, the composition comprises one or more cannabosides having formulas (IA) through (XXA):

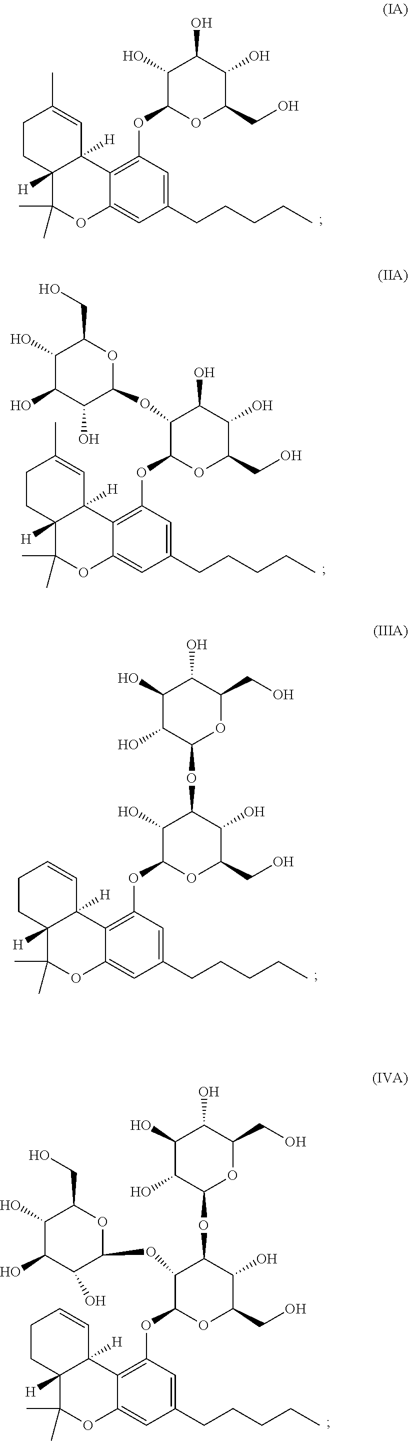

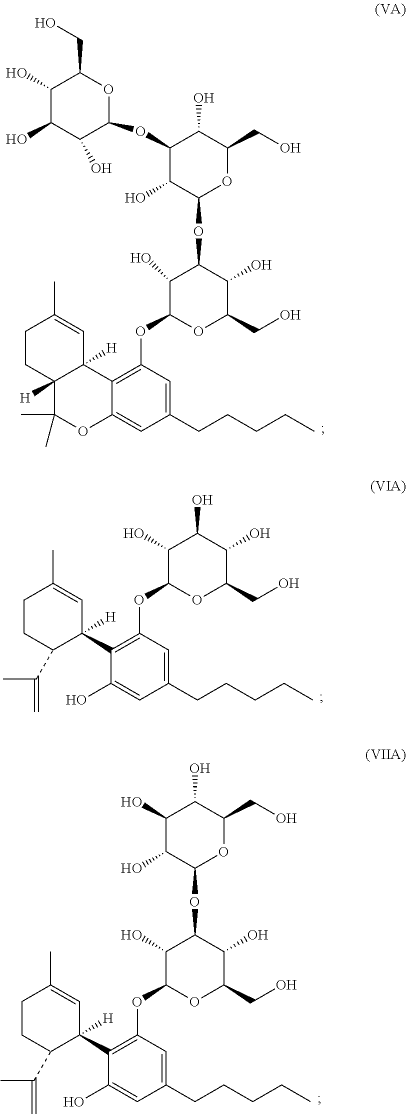

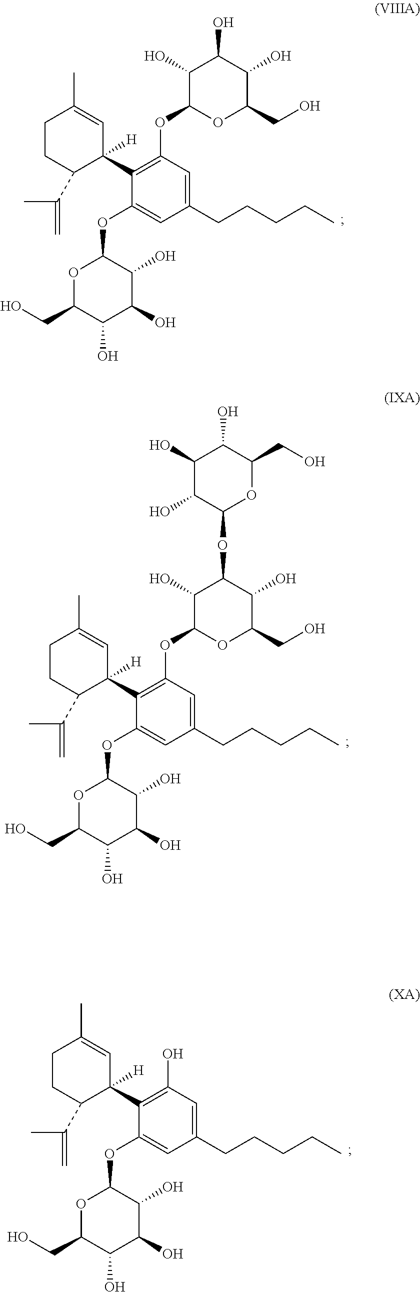 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O)[C@H]1O ; C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O)cc(CCCCC)cc1O[C@@H]1O[C@H](CO)[C@@H](O)[C@H](O)[C@H]1O]

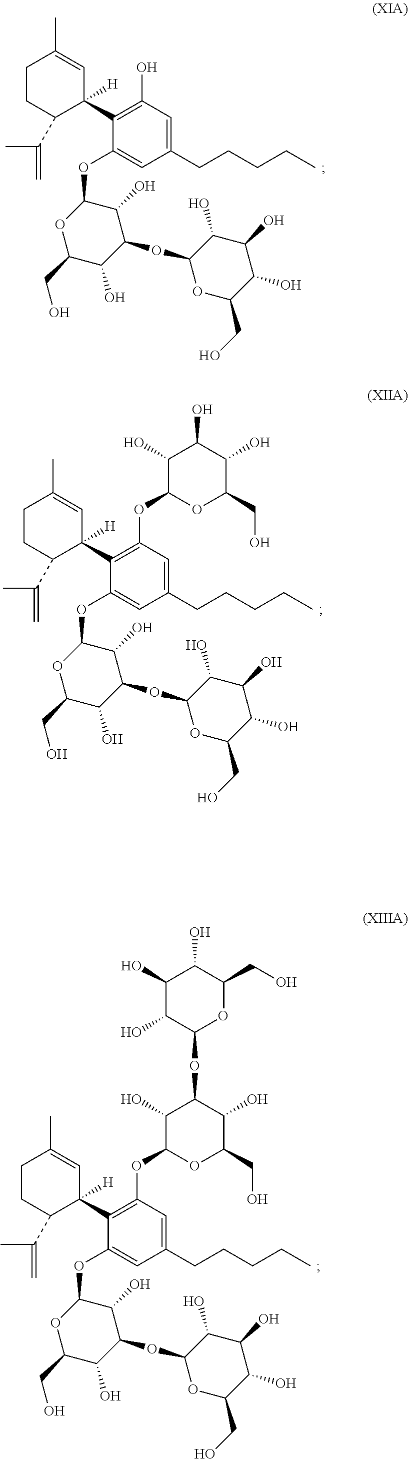

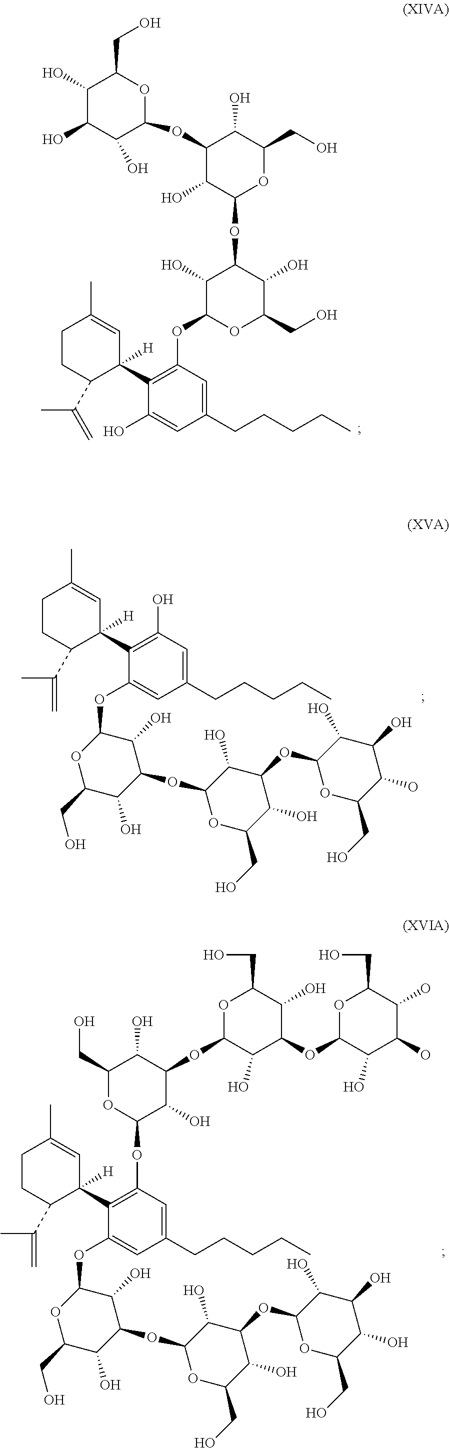

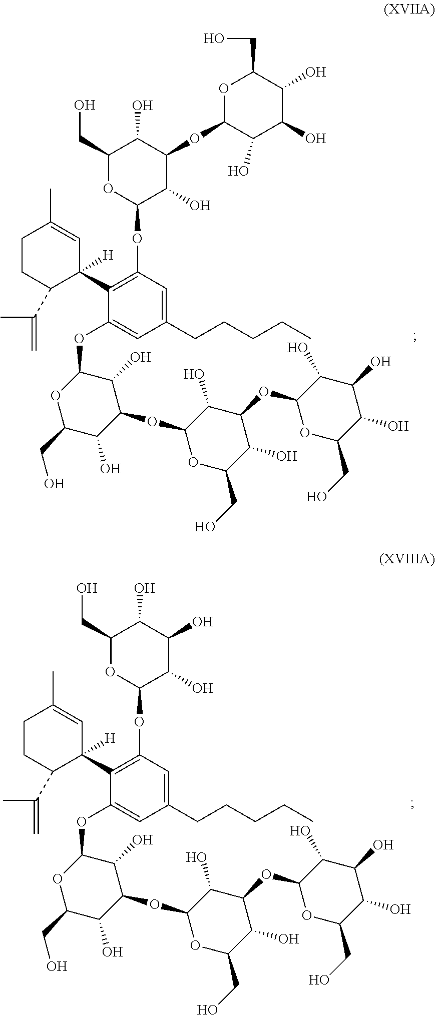 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O ; C=C(C)[C@@H]1CCC(C)=C[C@H]1c1c(O[C@H]2O[C@@H](CO)[C@H](O)[C@@H](O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O]

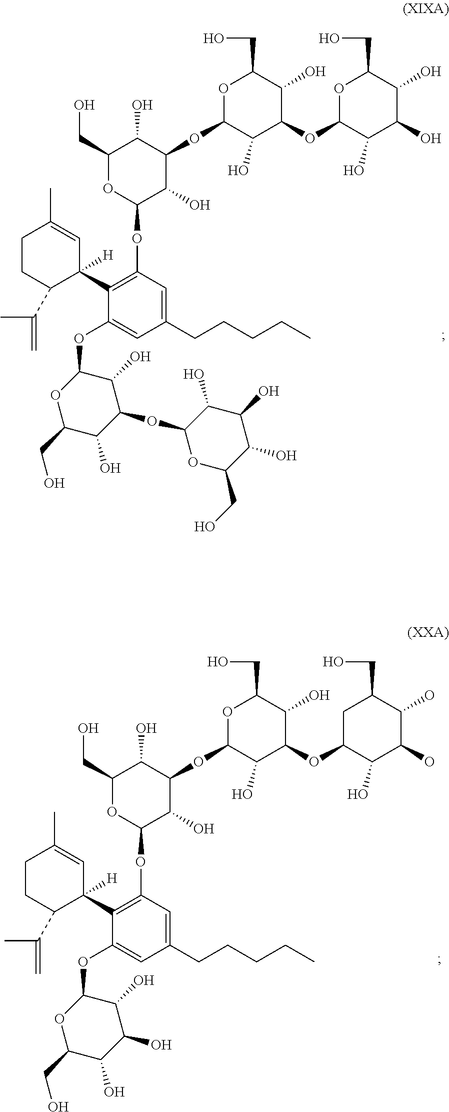 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4C[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O)[C@H]1O]

or a combination thereof.

In one or more aspects, the composition is a foodstuff suitable for human consumption subject to the proviso that the foodstuff is not honey. In one such aspect, the composition is or includes cricket powder.

In one or more aspects, at least one of the cannabosides and/or the cannabinoid metabolites present in the composition is soluble in water, i.e., a 1 wt % mixture of the at least one of the cannabosides and/or the cannabinoid metabolites in water forms a clear solution at 25° C.

In one or more aspects, the composition comprises greater than or equal to about 1 wt %, or greater than or equal to about 5 wt %, or greater than or equal to about 10 wt %, or greater than or equal to about 20 wt %, or greater than or equal to about 30 wt % of the one or more of cannabosides, cannabinoid metabolites, or a combination thereof, based on the total amount of the composition present.

In one or more aspects the composition is dispersed within a water soluble and/or a water dispersible matrix, also referred to herein as a solid formulation, in a dosage form. In one such aspect, the dosage form is dimensioned to be placeable within a beverage pod suitable for use in a single serve beverage brewing machine. In some aspects, the formulation is essentially free from maltodextrin. In aspects, the article is in a dosage form selected from the group consisting of a capsule, a cachet, a pill, a tablet, a powder, a granule, a pellet, a bead, a particle, a troche, nanoparticles disposed on a water soluble substrate, a nanofiber lattice, and a combination thereof.

In aspects, the composition may further include a solid carrier, an excipient, a binder, a colorant, a flavoring agent, a preservative, a buffer, a diluent, an excipient, an emulsifier, or a combination thereof. In some aspects, the composition may further include sucrose, lactose, dextrose, galactose, fructose, mannose, sorbitol, xylitol, starch, modified starch, cellulose, microcrystalline cellulose, methyl cellulose, carboxymethyl cellulose, croscarmellose, croscarmellose cellulose, a porous starch, a maize starch, a natural fiber, a natural fiber derived from citrus, a pectin, or a combination thereof.

In some aspects, the composition may include saccharine, a rebaudioside, erythritol, a steviol glycoside, aspartame, calcium phosphate, calcium sulfate, mannitol, magnesium stearate, potassium chloride, citric acid, gum arabic, sodium bicarbonate, or combination thereof. In aspects, the composition comprises one or more pH and/or buffering agents selected from the group consisting of propionic acid, p-toluenesulfonic acid, salicylic acid, stearic acid, succinic acid, tannic acid, tartaric acid, thioglycolic acid, toluenesulfonic acid, ammonium hydroxide, potassium hydroxide, sodium hydroxide, sodium hydrogen carbonate, aluminum hydroxide, calcium carbonate, and combinations thereof.

In aspects, the formulation comprises an absorbent and/or adsorbentm, also referred to herein as a solid carrier. In aspects, the carrier is essentially free of maltodextrine, (i.e., comprises less than about 0.1 wt % maltodextrine, if any, and/or wherein maltodextrine is not intentionally added to the formulation and if present, is present as an impurity or contaminant in another component. In aspects, the formulation is a solid, and the carrier comprises sucrose, lactose, dextrose, galactose, fructose, mannose, sorbitol, xylitol, starch, modified starch, cellulose, microcrystalline cellulose, methyl cellulose, carboxymethyl cellulose, croscarmellose, croscarmellose cellulose, a porous starch, a maize starch, a natural fiber, a natural fiber derived from citrus, a pectin, or a combination thereof.

In some aspects, the formulation comprises a nano porous starch aerogel, an agglomerated starch comprising a starch binding agent and starch granules, a thermally inhibited agglomerated starch, an amylopectin, a modified waxy maize starch, or a combination thereof. Suitable examples of solid absorbents include those disclosed in US20190136017, US20190000101, US20180343883, US20180327767, US20180209101, US20180209100, US20180192683, US20170283818, US20170282524, US20170282523, US20170282522, US20170282519, US20170282487, US20160053027, US20150201654 US20150083024, and US20150045454, the disclosures of which are fully incorporated by reference herein.

In aspects, a concentration of free THC, CBD, or both in the cannabinoid enriched composition is less than or equal to about 1000 ppm (i.e., less than about 0.1 wt %), preferably less than or equal to about 500 ppm, preferably less than or equal to about 100 ppm, preferably less than or equal to about 50 ppm, preferably less than or equal to about 20 ppm, based on the total amount of the composition present. For purposes herein, free THC, CBD, or both refers to the detection of the cannabinoids via HPLC-UV detection.

In one or more aspects, the composition may include fibrinogen; dextran; cellulose including cellulose, cellulose acetate, cellulose butyrate, cellulose acetate butyrate, cellophane, cellulose nitrate, cellulose propionate, cellulose ethers, and carboxymethyl cellulose; starch; pectin; chitosan; gelatin; alginate and conjugations thereof including alginate-gelatin, alginate-collagen, alginate-laminin, alginate-elastin, alginate-collagen-laminin and alginate-hyaluronic acid; collagen and conjugates thereof; hyaluronan; hyaluronic acid; sodium hyaluronate; modified hyaluronan such as tyramine-hyaluronate or glycidyl methacrylate hyaluronate; or self-assembled peptides including dipeptides, so called “lego peptides, ionic self-complementary peptides, surfactant peptides, molecular paint peptides, carpet peptides, cyclic peptides, and the like.

In one or more aspects, the composition may include one or more natural fibers, preferably fibers derived from citrus. In aspects, the natural fibers include citrus fiber, dried citrus pulp, and/or citrus flour ground to less than 30 mesh, or 100 mesh, or less than 200 mesh. Examples include Citri-Fi® (Fiberstar, USA). In some aspects, the natural fibers may further include guar gum, xanthan gum, and/or the like.

Suitable cannabinoids for use in the animal feed herein include both optically pure and racemic pairs of compounds which may be isolated from one or more of the Cannabis sativa plants including chemotypes I, II, III, and the like. Suitable cannabinoids present in the feed may also include cannabinoid glycosides, i.e., cannabosides. Suitable cannabinoids for use in the animal feed may be isolated from the Cannabis sativa plant and/or may be synthetically produced and/or modified, and/or biosynthesized. Unless explicitly stated otherwise, the term “cannabinoids” refers to one or more of the cyclized and/or uncyclized, substituted and/or unsubstituted forms of:

i) cannabigerol, according to the general formula:

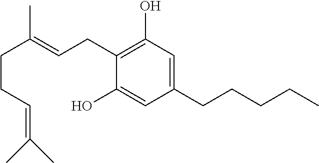

ii) cannabichromene, according to the general formula:

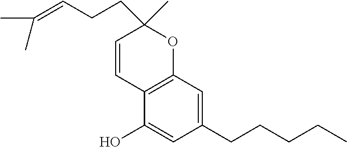

iii) cannabidiol, according to the general formula:

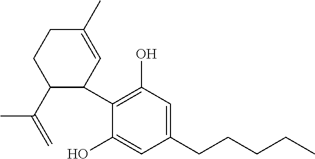

iv) tetrahydrocannabinol and/or cannabinol, according to the general formula:

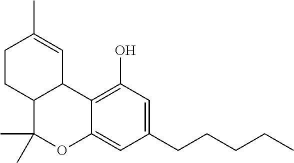

v) cannabielsoin, according to the general formula:

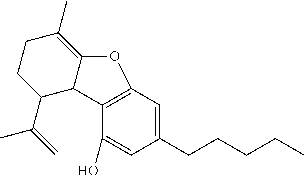

vi) iso-tetrahydrocannabinol, according to the general formula:

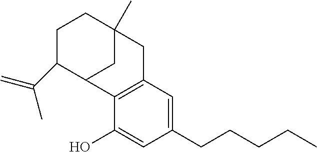

vii) cannabicyclol, according to the general formula:

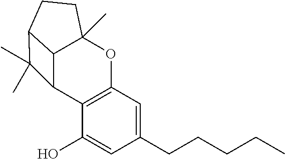

viii) cannabicitran, according to the general formula:

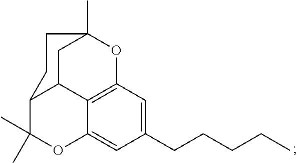

ix) tetrahydrocannabivarin (THCV), according to the general formula:

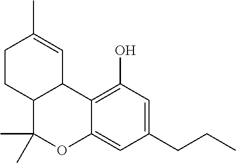

wherein any one or more of the various hydrogen atoms may be substituted with a functional group, and/or including the free acids, salts, tosylates, mesylates, esters, amides, ethers, sulfates, and/or other derivatives thereof.

In one aspect of the disclosure, the animal feed comprises one or more tetrahydrocannabinols (THC) in general, and (−)-trans-Δ⁹-tetrahydrocannabinol in particular, cannabidol (CBD), tetrahydrocannabinolic acid (THCA), cannabidiolic acid (CBDA), cannabinol (CBN), cannabigerol (CBG), cannabichromene (CBC) cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabielsoin (CBE), cannabicitran (CBT), cannabigerolic acid, cannabigerolic acid monomethylether, cannabigerol monomethylether, cannabigerovarinic acid, cannabichromenic acid, cannabichromevarinic acid, cannabidolic acid, cannabidiol monomethylether, cannabidiol-C4, cannabidivarinic acid, cannabidiorcol, delta-9-tetrahydrocannabinolic acid A, delta-9-tetrahydrocannabinolic acid B, delta-9-tetrahydrocannabinolic acid-C4, delta-9-tetrahydrocannabivarinic acid, delta-9-tetrahydrocannabivarin, delta-9-tetrahydrocannabiorcolic acid, delta-9-tetrahydrocannabiorcol, delta-7-cis-isotetrahydrocannabivarin, delta-8-tetrahydrocannabiniolic acid, delta-8-tetrahydrocannabinol, cannabicyclolic acid, cannabicylovarin, cannabielsoic acid A, cannabielsoic acid B, cannabinolic acid, cannabinol methylether, cannabinol-C4, cannabinol-C2, cannabiorcol, 10-ethoxy-9-hydroxy-delta-6a-tetrahydrocannabinol, 8,9-dihydroxy-delta-6a-tetrahydrocannabinol, cannabitriolvarin, ethoxycannabitriolvarin, dehydrocannabifuran, cannabifuran, cannabichromanon, cannabicitran, 10-oxo-delta-6a-tetrahydrocannabinol, delta-9-cistetrahydrocannabinol, 3, 4, 5, 6-tetrahydro-7-hydroxy-alpha-alpha-2-trimethyl-9-npropyl-2, 6-methano-2H-1-benzoxocin-5-methanol-cannabiripsol, trihydroxy-delta-9-tetrahydrocannabinol, cannabinol, and/or derivatives thereof.

In one or more aspects, the cannabosides and/or the cannabinoid metabolites present in the composition, which were produced by an animal which has been fed a feedstock comprising one or more cannabinoids, comprises a cannabinoid structure in which one or more of the phenolic hydrogens, when present, is replaced by a C₁-C₄ hydrocarbyl, preferably a C₃-C₄₀ carbohydrate, saccharide or polysaccharide, optionally comprising one or more functional groups, e.g., an aminosaccharide, a decasaccharide, a disaccharide, a glucosaccharide, a heptasaccharide, a heterosaccharide, a hexasaccharide, an isomaltosaccharide, a monosaccharide, an oligosaccharide, a pentasaccharide, a phosphosaccharide, a polysaccharide, a tetrasaccharide, a trisaccharide, a triose, tetrose, a pentose, a hexose, a heptose, a glycoside, and/or the like.

In one or more aspects the compositions comprises a cannabosides comprising the general formula:

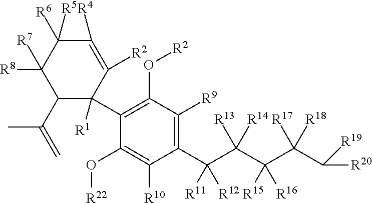

wherein one or more of R¹, R², R⁴, R⁵, R⁶, R⁷, R⁸, R⁹, R¹⁰, R¹¹, R¹², R¹³, R¹⁴, R, R¹⁶, R¹⁷, R¹⁸, R¹⁹, R²⁰, R²¹ and R²², are independently selected from hydrogen or one or more monovalent radicals including hydrocarbyl radicals such as methyl, ethyl, ethenyl, and all isomers (including cyclics such as cyclohexyl) of propyl, butyl, pentyl, hexyl, heptyl, octyl, nonyl, decyl, undecyl, dodecyl, propenyl, butenyl, and from halocarbyls and all isomers of halocarbyls including perfluoropropyl, perfluorobutyl, perfluoroethyl, perfluoromethyl, and from substituted hydrocarbyl radicals and all isomers of substituted hydrocarbyl radicals including trimethylsilylpropyl, trimethylsilylmethyl, trimethylsilylethyl, and from phenyl, and all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, dipropylmethylphenyl, and the like; from all isomers of halo substituted phenyl (where halo is, independently, fluoro, chloro, bromo and iodo) including halophenyl, dihalophenyl, trihalophenyl, tetrahalophenyl, and pentahalophenyl; and from all isomers of halo substituted hydrocarbyl substituted phenyl (where halo is, independently, fluoro, chloro, bromo and iodo) including halomethylphenyl, dihalomethylphenyl, (trifluoromethyl)phenyl, bis(triflouromethyl)phenyl; and from all isomers of benzyl, and all isomers of hydrocarbyl substituted benzyl including methylbenzyl, dimethylbenzyl, wherein R²¹ and/or R²², comprise a C₃-C₄₀ carbohydrate, saccharide or polysaccharide, optionally comprising one or more functional groups, e,g, an aminosaccharide, a decasaccharide, a disaccharide, a glucosaccharide, a heptasaccharide, a heterosaccharide, a hexasaccharide, an isomaltosaccharide, a monosaccharide, an oligosaccharide, a pentasaccharide, a phosphosaccharide, a polysaccharide, a tetrasaccharide, a trisaccharide, a triose, tetrose, a pentose, a hexose, a heptose, a glycoside, and/or the like.

In one or more aspects the compositions comprises a cannabosides comprising the general formula:

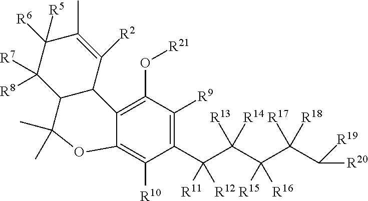

wherein one or more of R², R⁵, R⁶, R⁷, R⁸, R⁹, R¹⁰, R¹¹, R¹², R¹³, R¹⁴, R¹⁵, R¹⁶, R¹⁷, R¹⁸, R¹⁹, and R²⁰, are independently selected from hydrogen or one or more monovalent radicals including hydrocarbyl radicals such as methyl, ethyl, ethenyl, and all isomers (including cyclics such as cyclohexyl) of propyl, butyl, pentyl, hexyl, heptyl, octyl, nonyl, decyl, undecyl, dodecyl, propenyl, butenyl, and from halocarbyls and all isomers of halocarbyls including perfluoropropyl, perfluorobutyl, perfluoroethyl, perfluoromethyl, and from substituted hydrocarbyl radicals and all isomers of substituted hydrocarbyl radicals including trimethylsilylpropyl, trimethylsilylmethyl, trimethylsilylethyl, and from phenyl, and all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, dipropylmethylphenyl, and the like; from all isomers of halo substituted phenyl (where halo is, independently, fluoro, chloro, bromo and iodo) including halophenyl, dihalophenyl, trihalophenyl, tetrahalophenyl, and pentahalophenyl; and from all isomers of halo substituted hydrocarbyl substituted phenyl (where halo is, independently, fluoro, chloro, bromo and iodo) including halomethylphenyl, dihalomethylphenyl, (trifluoromethyl)phenyl, bis(triflouromethyl)phenyl; and from all isomers of benzyl, and all isomers of hydrocarbyl substituted benzyl including methylbenzyl, dimethylbenzyl, and wherein R²¹ comprise a C₃-C₄₀ carbohydrate, saccharide or polysaccharide, optionally comprising one or more functional groups, e,g, an aminosaccharide, a decasaccharide, a disaccharide, a glucosaccharide, a heptasaccharide, a heterosaccharide, a hexasaccharide, an isomaltosaccharide, a monosaccharide, an oligosaccharide, a pentasaccharide, a phosphosaccharide, a polysaccharide, a tetrasaccharide, a trisaccharide, a triose, tetrose, a pentose, a hexose, a heptose, a glycoside, and/or the like.

In one or more aspects, one or more of R¹, R², R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, and R²⁰, when present, is substituted with one or more functional groups selected from Br, Cl, F, I, —NR*2, —NR*—CO—R*, —OR*, *—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —GeR*₃, —SnR*₃, —PbR*₃, —(CH₂)q-SiR*₃, or a combination thereof, wherein q is 1 to 10 and each R* is independently hydrogen, a C₁-C₁₀ alkyl radical, and/or two or more R* may join together to form a substituted or unsubstituted completely saturated, partially unsaturated, or aromatic cyclic or polycyclic ring structure.

In aspects, at least a portion of the cannabosides present in the composition comprises a glucose and/or other carbohydrate conjugate, i.e., a glycoside, and/or as a glutathione conjugate, such as a glutathione S-conjugate. As used herein, a glutathione conjugate of a cannabinoid is a cannabinoid comprising a moiety derived from (2S)-2-Amino-4-{[(1R)-1-[(carboxymethyl)carbamoyl]-2-sulfanylethyl]carbamoyl}butanoic acid.

At least a portion of the cannabosides present in the composition are formed by feeding an animal a feedstock comprising cannabinoids.

In one or more aspects, the cannabosides comprise a cannabinoid in which at least one phenolic hydrogen has been replaced by a C₃-C₄₀ carbohydrate, saccharide or polysaccharide, optionally comprising one or more functional groups, e.g., an aminosaccharide, a decasaccharide, a disaccharide, a glucosaccharide, a heptasaccharide, a heterosaccharide, a hexasaccharide, an isomaltosaccharide, a monosaccharide, an oligosaccharide, a pentasaccharide, a phosphosaccharide, a polysaccharide, a tetrasaccharide, a trisaccharide, a triose, tetrose, a pentose, a hexose, a heptose, a glycoside, and/or the like.

In one or more aspects, the phenolic hydrogen, (e.g., R²⁰ and/or R²¹ above) is substituted with monovalent functional group comprising a triose, a tetrose, a pentose, a hexose, a heptose, a glycoside, and/or a combination thereof.

Suitable cannabosides include CBD-2′-O-glucopyranoside, CBD-6′-O-glucopyranoside, CBD-2′-O-(3-1)-diglucopyranoside, CBD-6′-O-(3-1)-diglucopyranoside, CBD-2′,6′-O-diglucopyranoside, Δ9-THC-2′-O-glucopyranoside, Δ9-THC-2′-O-(3-1)-diglucopyranoside, Δ9-THC-2′-O-(1-2)-diglucopyranoside, Δ9-THC-2′-O-(3-1)-(2,1)-triglucopyranoside, Δ9-THC-2′-O-(3-1)-(3,1)-triglucopyranoside, and the like.

In one aspect, the composition comprises one or more cannabosides comprising formula (IA) through (XXA) in Table 1:

TABLE 1

| | |
|---|---|
| 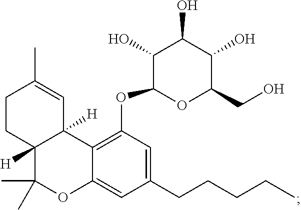 [SMILES: CCCCCc1cc(O[C@@H]2O[C@H](CO)[C@@H](O)[C@H](O)[C@H]2O)c2c(c1)OC(C)(C)[C@@H]1CCC(C)=C[C@@H]21] | (IA) |
| 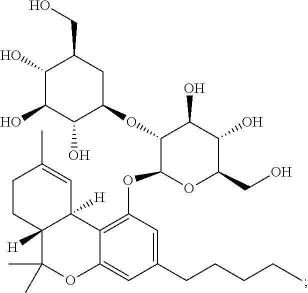 [SMILES: CCCCCc1cc(O[C@@H]2O[C@H](CO)[C@@H](O)[C@H](O)[C@H]2O[C@@H]2C[C@H](CO)[C@@H](O)[C@H](O)[C@H]2O)c2c(c1)OC(C)(C)[C@@H]1CCC(C)=C[C@@H]21] | (IIA) |
| 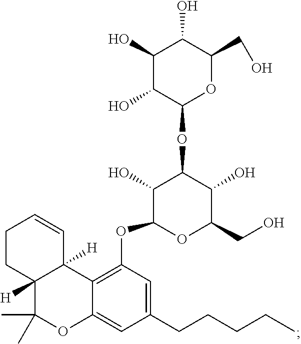 [SMILES: CCCCCc1cc(O[C@@H]2O[C@H](CO)[C@@H](O)[C@H](O[C@@H]3O[C@H](CO)[C@@H](O)[C@H](O)[C@H]3O)[C@H]2O)c2c(c1)OC(C)(C)[C@@H]1CCC=C[C@@H]21] | (IIIA) |
| 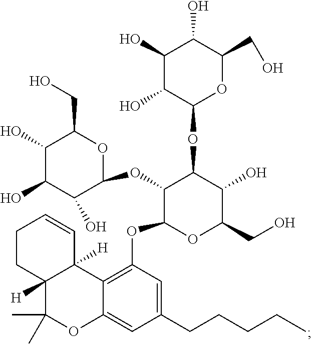 [SMILES: CCCCCc1cc(O[C@@H]2O[C@H](CO)[C@@H](O)[C@H](O[C@@H]3O[C@H](CO)[C@@H](O)[C@H](O)[C@H]3O)[C@H]2O[C@@H]2O[C@H](CO)[C@@H](O)[C@H](O)[C@H]2O)c2c(c1)OC(C)(C)[C@@H]1CCC=C[C@@H]21] | (IVA) |
| 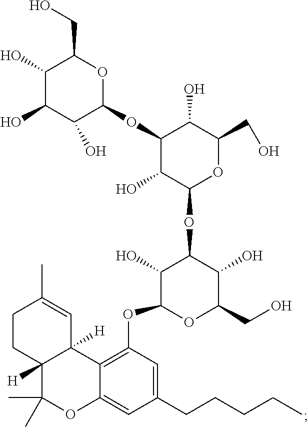 [SMILES: CCCCCc1cc(O[C@@H]2O[C@H](CO)[C@@H](O)[C@H](O[C@@H]3O[C@H](CO)[C@@H](O)[C@H](O[C@@H]4O[C@H](CO)[C@@H](O)[C@H](O)[C@H]4O)[C@H]3O)[C@H]2O)c2c(c1)OC(C)(C)[C@@H]1CCC(C)=C[C@@H]21] | (VA) |
| 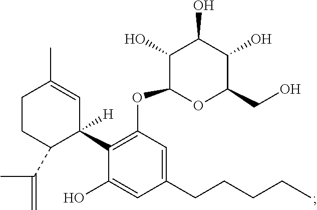 [SMILES: C=C(C)[C@@H]1CCC(C)=C[C@H]1c1c(O)cc(CCCCC)cc1O[C@@H]1O[C@H](CO)[C@@H](O)[C@H](O)[C@H]1O] | (VIA) |
| 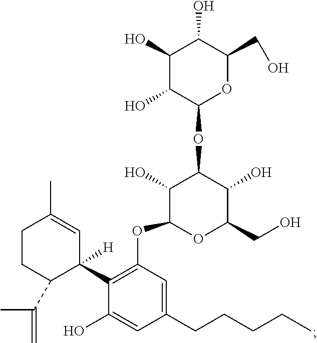 [SMILES: C=C(C)[C@@H]1CCC(C)=C[C@H]1c1c(O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (VIIA) |
| 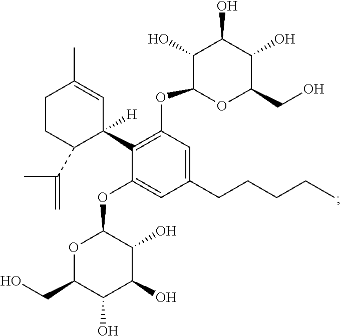 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O)[C@H]1O] | (VIIIA) |
| 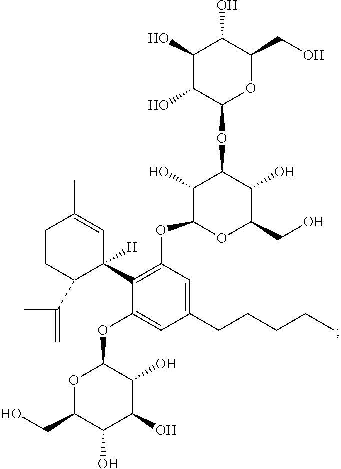 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (IXA) |
| 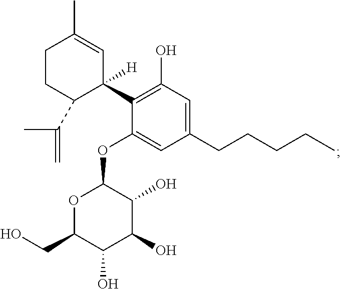 [SMILES: C=C(C)[C@@H]1CCC(C)=C[C@H]1c1c(O)cc(CCCCC)cc1O[C@@H]1O[C@H](CO)[C@@H](O)[C@H](O)[C@H]1O] | (XA) |
| 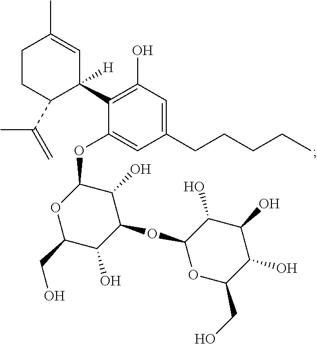 [SMILES: C=C(C)[C@@H]1CCC(C)=C[C@H]1c1c(O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (XIA) |
| 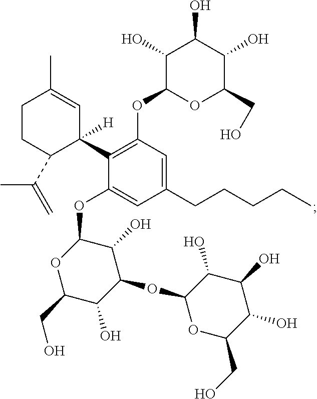 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (XIIA) |
| 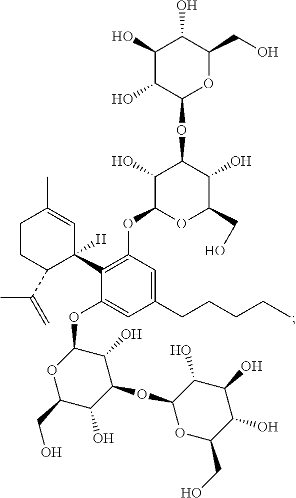 [SMILES: C=C(C)[C@@H]1CCC(C)=C[C@H]1c1c(O[C@@H]2O[C@H](CO)[C@@H](O)[C@H](O[C@@H]3O[C@H](CO)[C@@H](O)[C@H](O)[C@H]3O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (XIIIA) |
| 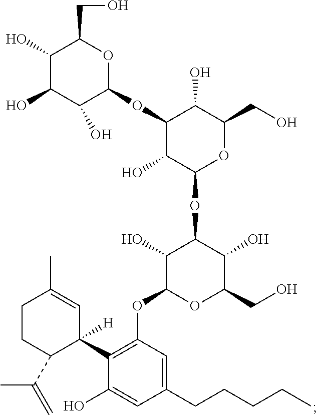 [SMILES: C=C(C)[C@@H]1CCC(C)=C[C@H]1c1c(O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] | (XIVA) |
| 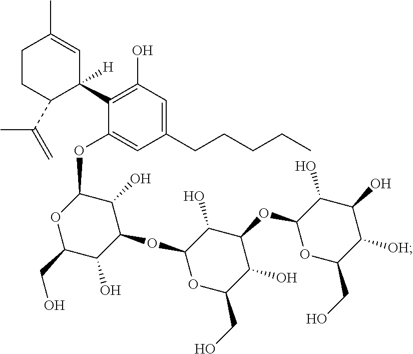 [SMILES: C=C(C)[C@@H]1CCC(C)=C[C@H]1c1c(O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] | (XVA) |
| 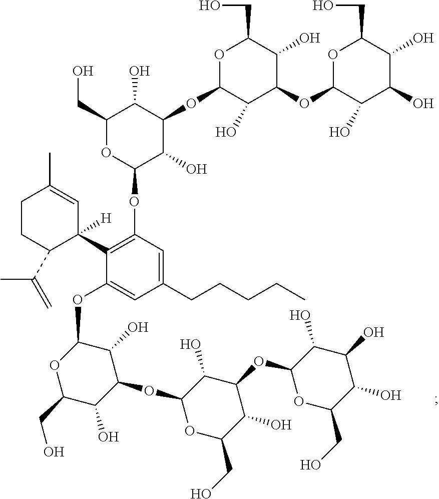 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] | (XVIA) |
| 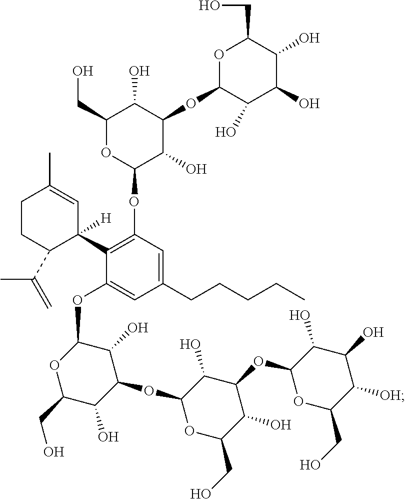 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] | (XVIIA) |
| 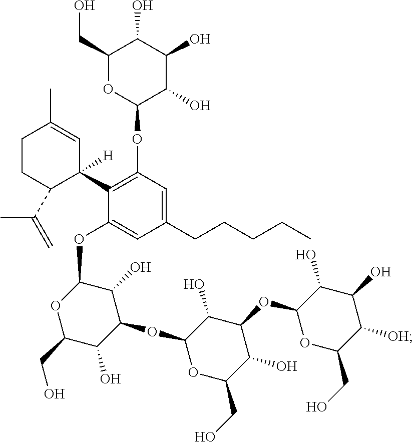 [SMILES: C=C(C)[C@@H]1CCC(C)=C[C@H]1c1c(O[C@H]2O[C@@H](CO)[C@H](O)[C@@H](O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] | (XVIIIA) |
| 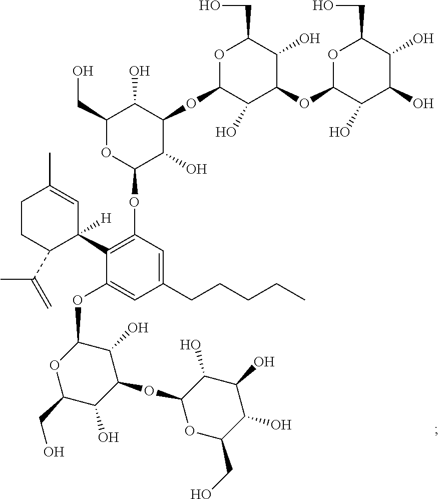 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O] | (XIXA) |
| 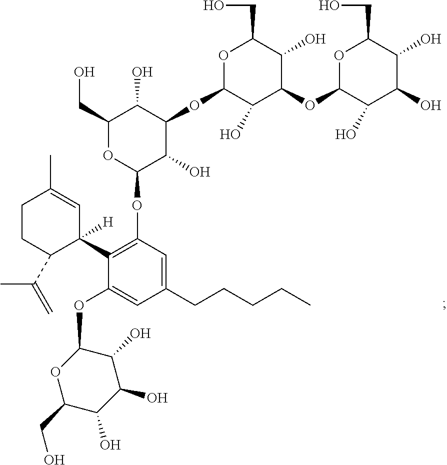 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O)[C@H]1O] | (XXA) |

or a combination thereof.

In aspects, the compositions according to the instant disclosure may further comprise one or more surfactants and/or a surfactant system. In some aspects, the surfactant is a phospholipid, a sugar fatty acid ester, a sucrose fatty acid ester, a polysorbate and a polysorbate analog, or a combination thereof. In one or more aspects of the composition, at least one surfactant has an HLB of greater than or equal to about 10 and/or further comprises at least one surfactant having an HLB of less than 10. In one or more aspects the surfactant system comprises a matched pair suitable for aqueous dispersion.

In one or more aspects the composition further comprises an emulsion stabilizer selected from the group consisting of xanthan gum, guar gum and sodium alginate; modified gum acacia; ester gum, or a combination thereof, and/or a pH adjuster present in an amount sufficient to adjust the pH of 1 wt % of the composition in deionized water to greater than or equal to about 6 and less than or equal to about 8 at 25° C.

The composition may further comprise a hydrophilic component, e.g., comprising one or more water soluble agents. Exemplary water soluble agents include, but are not limited to, carbohydrates, including complex carbohydrates such as starches, gum arabic, and quillaja extract; sugars such as monosaccharides (e.g., dextrose), oligosaccharides (e.g., cyclodextrins), and polysaccharides (e.g., maltodextrin); and polyols including, e.g., sugar alcohols such as sorbitol and maltitol. Additional water soluble agents that may be used herein include proteins (e.g., gelatin, whey, casein), phospholipids (e.g., soy lecithin, egg lecithin, etc.), glycerol monostearate, surfactants (such as, e.g., sorbitan, sorbitan esters, and polysorbates (e.g., sorbitan monolaurate, polyoxyethylene (20) sorbitan monolaurate, sorbitan monopalmitate, polyoxyethylene (20) sorbitan monopalmitate, sorbitan monostearate, polyoxyethylene (20) sorbitan monostearate, sorbitan tristearate, sorbitan monooleate, polyoxyethylene (20) sorbitan monooleate, etc.), and other emulsifiers and water soluble agents suitable for human consumption. The water soluble agent(s) may have a chemical structure that includes a hydrophilic region to promote solubility. Without intending to be bound by theory, it is believed that the water soluble agent(s) may promote solubility of the cannabinoid compounds, e.g., by at least partially absorbing the cannabinoid compounds or otherwise associating the cannabinoid compounds with hydrophilic portions of the water soluble agent.

Examples of water soluble agents include those comprising one or more complex carbohydrates, including e.g., natural carbohydrates such as starches, gum arabic, and quillaja extract. The starch may be a food starch (e.g., waxy maize, corn, potato, wheat, tapioca, or cassava, etc.), and may be relatively high in amylopectin and/or chemically modified to increase an oil absorption capacity of the starch. Examples of starches suitable for the compositions herein include different types of modified food starches, including, but not limited to, octenyl succinic anhydride (OSA) starch. In some examples, the composition may comprise at least one complex carbohydrate in combination with one or more other water soluble agents, such as, e.g., oligosaccharides, polysaccharides, surfactants, and/or polyols. Further, for example, the composition may comprise two or more different complex carbohydrates, optionally in combination with one or more oligosaccharides, polysaccharides, surfactants, and/or polyols. Commercial examples of water soluble agents suitable for the compositions and methods herein include, but are not limited to, CAPSUL®. starch, PURITY GUM® starch, N-ZORBIT® starch, PENBIND® starch, N-Lite® LP starch, and Q-Naturale® quillaja extract produced by Ingredion; and Span® 20, Span® 40, Span® 60, Span® 80, Tween® 20, Tween® 40, Tween® 60, and Tween 80, produced by Croda International PLC.

In some aspects, the composition comprises at least one water soluble agent chosen from a complex carbohydrate, a polyol, a polysaccharide, an oligosaccharide, or a combination thereof. For example, the water soluble agent(s) may comprise a starch, quillaja extract, maltodextrin, a sugar alcohol, or a combination thereof. In at least one example, the water soluble agent(s) comprise a modified food starch, sorbitol, or both. According to some aspects of the present disclosure, the composition comprises at least two water soluble agents. For example, the composition may comprise two or more different water soluble agents chosen from complex carbohydrates, polyols, polysaccharides, oligosaccharides, and combinations thereof. Further, for example, the two or more different water soluble agents may be chosen from modified food starches, sugar alcohols, quillaja extract, maltodextrin, or combinations thereof. In some examples, the two different water soluble agents comprise a starch and a sugar alcohol.

Certain water soluble agent(s) may provide sweetness to the composition. For example, sorbitol is a sugar alcohol that is generally understood to be metabolized at a slower rate than sugar, and thus may be described as a sugar substitute. Further, for example, maltodextrin is a long-chain polysaccharide that may be described as moderately sweet. In general, a longer chain length corresponds to a composition with less sweetness. For example, the water soluble agent(s) may comprise a polysaccharide or oligosaccharide that does not provide any sweetness, e.g., a polysaccharide or oligosaccharide that is flavorless.

In some examples herein, the weight ratio of water soluble agent(s) to hydrophobic component (i.e., purified oil distillate and carrier oil(s), if any) may range from about 10:1 to about 1:100, such as from about 5:1 to about 1:50, from about 4:1 to about 1:20, from about 3:1 to about 1:15, from about 2:1 to about 1:10, or from about 4:1 to about 1:4, e.g., a ratio of about 10:1, 5:1, 4:1, 3:1, 5:2, 2:1, 4:3, 1:1, 3:4, 1:2, 2:5, 1:3, 1:4, 1:5, 1:10, 1:25, 1:50, 1:75, or 1:100. In some examples, the weight ratio of water soluble agent(s) to the hydrophobic component ranges from about 1:5 to about 2:1, e.g., a weight ratio of up to about 1:1, up to about 1:2, up to about 1:3, up to about 1:4, or up to about 1:5.

In aspects, the surfactant is a phospholipid, a sugar fatty acid ester, a sucrose fatty acid ester, a polysorbate and a polysorbate analog, or a combination thereof. In some aspects, at least one surfactant has an HLB of greater than or equal to about 10 and/or may further comprise at least one surfactant having an HLB of less than 10.

The compositions may further include one or more other or co-surfactants to improve emulsification of the cannabinoid and/or the stability of the composition, for example, by preventing or slowing oxidation of the cannabinoid or other ingredient.

Suitable surfactants include phospholipids, for example, phosphatidylcholine. Other exemplary surfactants include non-ionic surfactants, such as sugar-derived surfactants, including fatty acid esters of sugars and sugar derivatives, and PEG-derived surfactants, such as PEG derivatives of sterols, PEG derivatives of fat-soluble vitamins and PEG-sorbitan fatty acid esters. Polyethylene/polypropylene/polybutene glycols may also be used.

When present, the amount of the surfactant is typically less than or equal to about 10 wt %, typically less than or less than about 5%, for example, the total amount of surfactant as a percentage (%), by weight, of the composition can be, e.g., less than or less than about 10%, such as less than or about 5%, 4.5%, 4%, 3.5%, 3.15%, 3%, 2.5%, 2%, 1.75%, 1.5%, 1.25%, 1%, 0.75%, 0.5%, 0.25%, 0.15% or less, by weight, of the total composition.

Suitable phospholipids include, but are not limited to lecithin, including phosphatidylcholine (PC), phosphatidylethanolamine (PE), distearoylphosphatidylcholine (DSPC), phosphatidylserine (PS), phosphatidylglycerol (PG), phosphatidic acid (PA), phosphatidylinositol (PI), sphingomyelin (SPM) or a combination thereof. Typically, the phospholipid is phosphatidylcholine (PC), which sometimes is referred to by the general name “lecithin.” Exemplary of the phospholipids that can be used as co-surfactants in the provided compositions are the phospholipids sold by Lipoid, LLC (Newark, N.J.), for example, Purified Egg Lecithins, Purified Soybean Lecithins, Hydrogenated Egg and Soybean Lecithins, Egg Phospholipids, Soybean Phospholipids, Hydrogenated Egg and Soybean Phospholipids, Synthetic Phospholipids, PEG-ylated Phospholipids and phospholipid blends. Exemplary of the phosphatidylcholine that can be used as a co-surfactant in the provided compositions is the phosphatidylcholine composition sold by Lipoid, LLC, under the name Lipoid S100, which is derived from soy extract and contains greater than or greater than about 95% phosphatidylcholine.

Suitable sugar-derived surfactants include, but are not limited to, sugar fatty acid esters including fatty acid esters of sucrose, glucose, maltose and other sugars, esterified to fatty acids of varying lengths (e.g., containing a varying numbers of carbons). The fatty acids typically have carbon chains between 8 and 28 carbons in length, and typically between 8 and 20, or between 8 and 18 or between 12 and 18, such as, but not limited to, stearic acid (18 carbons), oleic acid (18 carbons), palmitic acid (16 carbons), myristic acid (14 carbons) and lauric acid (12 carbons). Typically, the sugar ester surfactants are sucrose ester surfactants, typically sucrose fatty acid ester surfactants.

Suitable polyalkylene derived surfactants include, but are not limited to PEG derivatives of sterols, e.g., a cholesterol or a sitosterol (including, for example, any of the PEG derivatives disclosed in U.S. Pat. No. 6,632,443); PEG derivatives of fat-soluble vitamins, for example, some forms of vitamin A (e.g., retinol) or vitamin D (e.g., vitamin D1-D5); and PEG-sorbitan fatty acid esters, such as polysorbates, including polyoxyethylene (20) sorbitan monooleate (also called polysorbate 80) and analogs (e.g., homologs) of polysorbate 80, such as, for example, polysorbate 20 (polyoxyethylene (20) sorbitan monolaurate), polysorbate 40 (polyoxyethylene (20) sorbitan monopalmitate) and polysorbate 60 (polyoxyethylene (20) sorbitan monostearate); and stearic acid derivatives, including, for example, polyethylene glycol 400 distearate (PEG 400 DS), such as the PEG 400 DS sold by Stepan Lipid Nutrition (Maywood, N.J.).

Suitable sugar fatty acid ester surfactants include sucrose fatty acid esters wherein the fatty acid contains between 4 and 28 carbon atoms, typically between 8 and 28 carbon atoms, and typically between 8 and 25 carbon atoms, such as between 8 and 18 carbon atoms, such as 8, 9, 10, 11, 12, 13, 14, 15, 16, 17 and 18 carbon atoms. The fatty acid can be synthetic or naturally occurring and include linear and branched fatty acids. The fatty acids include, but are not limited to, myristic acid, palmitic acid, stearic acid, oleic acid, caproic acid, capric (or decanoic) acid, lauric acid, caprylic acid and pelargonic (or nonanoic) acid.

In aspects, the sugar fatty acid ester is a sucrose fatty acid ester surfactant which may be sucrose monoesters, diesters, triesters and polyesters, and mixtures thereof, and typically contain sucrose monoesters. The sucrose fatty acid ester surfactants include single fatty acid esters and also include homogeneous mixtures of sucrose esters, containing members with different lengths of fatty acid carbon chain and/or members with different degrees of esterification. For example, the sucrose fatty acid ester surfactants include mixtures of monoesters, diesters, triesters, and/or polyesters. The sugar ester surfactants further include sucrose fatty acid ester analogs and homologs and mixtures thereof.

Suitable sucrose fatty acid esters include mixtures of sucrose fatty acid esters, and may have varying HLB values, such as HLB values ranging from at or about 1 to at or about 20. The HLB value of the sucrose fatty acid ester generally depends on the degree of esterification (e.g., the average degree of esterification in a mixture of different esters). Typically, the lower the degree of esterification (e.g., average degree), the higher the HLB value of the sucrose fatty acid ester or mixture thereof. Exemplary sucrose esters include sucrose distearate (HLB=3), sucrose distearate/monostearate (HLB 12), sucrose dipalmitate (HLB=7.4), sucrose monostearate (HLB=15), sucrose monopalmitate (HLB>10), sucrose monolaurate (HLB 15). Typically, the sucrose fatty acid ester surfactants in aspects of the composition have an HLB value of between at or about 13 and at or about 20, such as at or about 13, 14, 15, 16, 17, 18, 19, or 20, and typically between at or about 13 and at or about 18, such as, but not limited to, HLB values of at or about 15, 16 and 17, such as, for example, sucrose ester surfactants including sucrose monopalmitate, sucrose monolaurate and sucrose monostearate.

In aspects the sucrose ester mixtures have at least at or about 50%, by weight (w/w), monoester, such as at least or about at least 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100%, by weight (w/w), sucrose monoesters, and typically at least at or about 60%, by weight, or at least at or about 70%, by weight (w/w), monoesters.

Suitable examples of sucrose fatty acid ester surfactants include sucrose fatty acid monoesters, such as sucrose monocaprylate, sucrose monodecanoate, sucrose monolaurate, sucrose monomyristate, sucrose monopalmitate, sucrose monostearate, sucrose monopelargonate, sucrose monoundecanoate, sucrose monotridecanoate, sucrose monopentadecanoate and sucrose monoheptadecanoate. The sucrose fatty acid esters further include mixtures containing varying percentages of monoesters, diesters, triesters and polyesters, such as, but not limited to, a mixture having at or about 72% monoesters, 23% diesters, 5% triesters and 0 polyesters; a mixture having at or about 61% monoesters, 30% diesters, 7% triesters, and 2% polyesters; and a mixture having at or about 52% monoesters, 36% diesters, 10% triesters and 2% polyesters.

In aspects, the composition further includes one or more emulsion stabilizers (co-emulsifiers), which can be used to stabilize the liquid emulsion upon dilution of the composition into an aqueous solvent. In aspects, the emulsion stabilizer functions to increase the viscosity of aspects of the composition or the mixture produced by dilution thereof.

Exemplary of an emulsion stabilizer that can be used in the provided compositions is a composition containing a blend of gums, for example, gums used as emulsifying agents, for example, a blend containing one or more of xanthan gum, guar gum and sodium alginate. Exemplary of such an emulsion stabilizer includes the emulsion stabilizer sold under the brand name SALADIZER®, available from TIC Gums, Inc. (Belcamp, Md.). Other gums can be included in the emulsion stabilizer, for example, gum acacia, ester gums and sugar beet pectin. Exemplary emulsion stabilizers include modified food starches. These include the modified gum acacia sold under the name Tic Pretested® Ticamulsion A-2010 Powder, available from TIC Gums, Inc. (Belcamp, Md.). Other exemplary emulsion stabilizers containing an ester gum are, for example, the emulsion stabilizer sold under the name Tic Pretested® Ester Gum 8BG, available from TIC Gums, Inc. (Belcamp, Md.) or Ester Gum 8BG, available from Hercules/Pinova (Brunswick, Ga.). Others sold by Ingredion, Inc (Westchester, Ill.) under the trademarks CAPSUL®, FIRMTEX®, THERMFLO®, THERMTEX®, and TEXTRA® and others, can be included in the compositions provided herein. Other blends of similar gums can also be used as emulsion stabilizers.

The emulsion stabilizer can be added to the water phase, the oil phase, or both the water and the oil phase, during formation of the particulates. In aspects, the emulsion stabilizer is present in the composition at greater than or equal to about 0.1 wt % or about 0.1% and 1% or about 1%, for example, 0.1%, 0.12%, 0.13%, 0.14%, 0.15%, 0.16%, 0.17%, 0.18%, 0.19%, 0.2%, 0.25%, 0.3%, 0.31%, 0.32%, 0.33%, 0.34%, 0.35%, 0.36%, 0.37%, 0.38%, 0.39%, 0.4%, 0.5%, 0.6%, 0.7%, 0.8%, 0.9% or 1 wt %, or 5%, 10%, 15%, 18%, 20%, or 25%, by weight, or more.

The composition may further include one or more flavoring agents, for example, any compound that can add flavor upon dilution into an aqueous liquid. Exemplary of flavors that can be used are fruit flavors, such as guava, kiwi, peach, mango, papaya, pineapple, banana, strawberry, raspberry, blueberry, orange, grapefruit, tangerine, lemon, lime and lemon-lime; cola flavors, tea flavors, coffee flavors, chocolate flavors, dairy flavors, root beer and birch beer flavors, methyl salicylate (wintergreen oil, sweet birch oil), citrus oils and other flavors. Typically, the flavors are safe and/or desirable for human consumption, for example, GRAS or Kosher-certified flavors. An exemplary flavoring agent that can be used in aspects of the composition include lemon oil, for example lemon oil sold by Mission Flavors (Foothill Ranch, Calif.), and D-limonene, for example, 99% GRAS certified D-Limonene, sold by Florida Chemical (Winter Haven, Fla.).

In aspects, the composition further includes one or more pH adjusters which may be added at an appropriate concentration to achieve a desired pH. Suitable pH adjuster are added to adjust the pH of the mixture produced upon dilution of the particulates in water to a pH of greater than or equal to about 2 to less than or equal to about 9, or from about 2 to 8, or 5 to 7.5, or from 3 to 4.0 or 4 to 6. In aspects, the pH adjuster present in an amount sufficient to adjust the pH of 1 wt % of the composition in deionized water to greater than or equal to about 6 and less than or equal to about 8 at 25° C.

One or more of a plurality of pH adjusting agents can be used. Typically, the pH adjusting agent is safe for human consumption, for example, GRAS certified. The pH adjuster can be citric acid. An exemplary pH adjuster suitable for use with aspects of the composition includes the citric acid sold by Mitsubishi Chemical (Dublin, Ohio). Another exemplary pH adjuster is phosphoric acid, such as Food Grade 80% Phosphoric Acid, sold by Univar. Various buffer compositions may also be employed.

Typically, the concentration of pH adjuster added according to aspects of the composition at less than 5% or about 5%, for example, less than or about 4%, 3.5%, 3%, 2.5%, 2%, 1.5%, 1%, 0.9%, 0.8%, 0.7%, 0.6%, 0.5%, 0.4%, 0.3%, 0.2%, 0.1% or less, by weight, of the composition.

In aspects the composition my further include various other components such as soluble fiber. Soluble fibers include any soluble dietary fiber that can be readily fermented in the colon, typically a plant based dietary fiber, for example, a soluble fiber from legumes, vegetables, such as broccoli and carrots, root vegetables, such as potatoes, sweet potatoes and onions, oats, rye, chia, barley and fruits, such as prunes, plums, berries, bananas, apples and pears. Typically, soluble dietary fiber contains non-starch polysaccharides, such as arabinoxylans, cellulose, dextrans, inulin, beta-glucans, fructo-oligosaccharides, oligosaccharides and polysaccharides. Soluble fibers include, but are not limited to, fructo-oligosaccharides, for example, inulins, for example, inulins found in chicory, Jerusalem artichoke, dahlia, garlic, leeks and onions, fructans and water-soluble soybean fiber. Exemplary of a soluble fiber is an inulin, for example, Oliggo-Fiber Instant Inulin (Fibruline® Instant) (supplied by Cosucra-Groupe Warcoing SA, Belgium, sold by Gillco Products, San Marcos, Calif.), containing chicory inulin.

Other additional components include sweeteners, glidents, anti-caking agents, antifoaming agents, and the like.

In one or more aspects, the composition my further include one or more stabilizers, or a stabilizing system. Stabilizers include any compound used to stabilize the cannabinoids and/or other non-polar ingredients in the composition, and/or upon dilution of the composition in an aqueous solvent. Suitable stabilizer or stabilizing systems include, but are not limited to, carbonates and bicarbonates, acids, antioxidants, and any combination thereof. Typically, the stabilizers or stabilizing system are food-approved, i.e., edible or ingestible, stabilizers, for example, stabilizers that are safe and/or approved for human consumption.

Suitable stabilizers include sodium bicarbonate, potassium bicarbonate, sodium carbonate, potassium carbonate, calcium carbonate, magnesium carbonate, zinc carbonate, and any combination thereof. Other stabilizers include acids such as citric acid, phosphoric acid, adipic acid, ascorbic acid, lactic acid, malic acid, fumaric acid, gluconic acid, succinic acid, tartaric acid, maleic acid, and any combination thereof.

Other stabilizers include antioxidants such as, but are not limited to hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, vitamins and vitamin cofactors, such as vitamin A, vitamin C, vitamin E, vitamin E phosphate and ubiquinone (ubidecarenone, coenzyme Q, coenzyme Q10), ascorbic acid, citric acid, rosemary oil, minerals, such as mineral selenium and manganese, melatonin, alpha-carotene, .beta.-carotene, lycopene, lutein, zeanthin, crypoxanthin, resveratrol, eugenol, quercetin, catechin, gossypol, hesperetin, curcumin, ferulic acid, thymol, hydroxytyrosol, tumeric, thyme, olive oil, lipoic acid, glutathione, gulamine, oxalic acid, tocopherol-derived compounds, di-alpha-tocopheryl phosphate, tocotrienols, butylated hydroxyanisole, butylated hydroxytoluene, ethylenediaminetetraacetic acid, tert-butylhydroquinone, acetic acid, pectin, tocotrienol, tocopherol, coenzyme Q10 (coQ10), zeaxanthin, astaxanthin, canthaxanthin, saponins, limonoids, kaempferol, myricetin, isorhamnetin, proanthocyanidins, quercetin, rutin, luteolin, apigenin, tangeritin, hesperetin, naringenin, eriodictyol, flavan-3-ols (e.g., anthocyanadins), gallocatechins, epicatechin and its gallate forms, epigallocatechin and its gallate forms theaflavin and its gallate forms, thearubigins, isoflavone phytoestrogens, genistein, daidzein, glycitein, anythocyanins, cyaniding, delphinidin, malvidin, pelargonidin and peonidin. In one example, the antioxidant is vitamin C. In another example, the antioxidant is a coenzyme Q-containing compounds, such as ubiquinone (ubidecarenone, coenzyme Q, coenzyme Q10).

### Stability

In aspects, the composition or the liquids produced by dilution of the composition are free from one or more changes over a period of time, for example, 1 or more days, 1 or more weeks, 1 or more months, or one or more years, for example, 1, 2, 3, 4, 5, 6, 7 or more days, 1, 2, 3, 4, 5, 6, 7, 8, 9, 10 or more weeks, 1, 2, 3, 4, 5, 6, 7, 8, 9, 10, 11, 12 or more months or 1, 2, 3, 4 or more years.

### Articles

In one or more aspects, the composition, or the liquids produced by dilution of the composition exhibit a high or relatively high bioavailability, for example, a bioavailability that is higher than a liquid containing the cannabinoid alone (i.e., not formulated according to aspects disclosed herein). Bioavailability relates to the ability of the body to absorb the cannabinoid into a particular space, tissue cell and/or cellular compartment.

In aspects the article is a solid dosage form, one or more aspects of the article disclosed herein can be used in conjunction with producing a beverage, preferably a coffee or tea product (with additional flavor if desired) with a consistent amount of one or more cannabosides using a coffee brewer, preferably but not necessarily a single serve coffee brewer, consistent with those readily available for both home and commercial use. The coffee brewer can be any conventional coffee brewer that makes single or multiple cups of coffee. For example, the coffee product can be obtained by using a beverage pod, e.g., a K-Cup® (Keurig Green Mountain, Inc., USA) suitable for use in a single-serving coffee brewing system. Wherein each beverage pod is a plastic or metal container comprising an inner chamber bound and formed by a top, a bottom and a plurality of sides, typically with a coffee filter inside and ground coffee beans (flavored or unflavored) or other brewable material such as tea or a beverage concentrate, e.g., powered coco drink, into which the article comprising a formulation for human ingestion comprising one or more cannabinoids dispersed within a water soluble and/or a water dispersible matrix in a dosage form which is dimensioned to be placeable within, and has been disposed within. In aspects, the beverage pod includes one or more articles, each in dosage form to produce a beverage having a particular amount of the one or more cannabinoids, which is disposed in and sealed within the beverage pod, e.g., the article, a dosage pill, is sealed air-tight within the inner chamber of the beverage pod, along with the coffee or tea, by a plastic and/or foil lid common in the art. When the beverage pod is placed in a like-configured and accommodating brewer apparatus, the brewer punctures both the upper lid and the bottom of the beverage pod and forces hot water under pressure through the top of the beverage pod which flows therethrough, through the puncture in the bottom of the beverage pod and into a cup to provide a consumable coffee drink. As the water flows through the beverage pod, the article is at least partially dissolved and/or dispersed thereby releasing the one or more cannabinoids which flow into the beverage cup.

The dosage form of the article ensures a specified quantity of the one or more cannabosides is present in the final beverage.

In other aspects, the composition is a food additive and/or a component used in preparing food. Examples include various forms of flour and other solid materials commonly utilized in food. In one aspect, the composition comprises cricket powder.

### Method to Produce

In one or more aspects, a method to produce the composition comprises feeding an animal a feedstock comprising one or more cannabinoids; harvesting the animal; and freeze-drying, lyophilizing, dehydrating, and/or masticating at least a portion of the animal to produce a composition comprising one or more cannabosides, cannabinoid metabolites, or a combination thereof produced by the animal. In one aspect, the method may further comprise contacting at least a portion of the harvested animal with a solvent to produce a mixture; filtering the mixture, and collecting the solvent to produce an extract comprising the one or more cannabosides, cannabinoid metabolites, or a combination thereof.

The feedstock may be hemp, may include hemp, and/or may be whatever is appropriate for the particular animal which has been contacted or otherwise enriched with one or more cannabinoids. For example, cricket feed may be sprayed with a cannabinoid containing material and then fed to the crickets. Likewise, hemp or other forms of cannabis may be included in the feedstock for the animal.

In one aspect, the solvent is water, or an aqueous solvent. Suitable solvents include alcohols, preferably ethanol. In another aspect, an organic solvent is used. Suitable examples include esters, amines, ketones, aromatic solvents, hydrocarbon solvents, halogenated solvents, and combinations thereof. In aspects in which the solvent is not suitable for human ingestion, the solvent must be removed from the extract, which may include heating and/or reduced pressure evaporation. In aspects of the disclosure, the process further comprises removing at least a portion of the solvent from the extract. In one or more aspects, a 1 wt % mixture of the final extract in water is a clear solution at 25° C.

To prevent the presence of TCH or other free cannabinoids being present in the composition, in one or more aspects, the method further comprises stopping the feeding of the animal with the feedstock comprising the cannabinoid and feeding the animal a feedstock which does not comprise one or more cannabinoids prior to harvesting. In this way, the undigested cannabinoids are not present in the final composition.

### Aspect Listing

One or more aspects include:
A1. A composition, comprising:
   one or more cannabosides, cannabinoid metabolites, or a combination thereof produced by an animal which has been fed a feedstock comprising one or more cannabinoids.
A2. The composition according to aspect A1, comprising at least a portion of the animal which has been fed the feedstock comprising one or more cannabinoids.
A3. The composition according to aspect A1 or A2, wherein at least a portion of the animal has been freeze-dried, lyophilized, dehydrated, masticated, or a combination thereof.
A4. The composition according to any one of aspects A1 through A3, wherein the one or more cannabosides, cannabinoid metabolites, or a combination thereof present in the composition are produced by extracting at least a portion of the animal which has been fed a feedstock comprising one or more cannabinoids with a solvent.
A5. The composition according to any one of aspects A1 through A4, wherein the animal is an insect subject to the proviso that the animal is not a bee.
A6 The composition according to any one of aspects A1 through A5, wherein the animal belongs to the Orthoptera order.
A7. The composition according to any one of aspects A1 through A6, in the form of a free-flowing solid.
A8. The composition according to any one of aspects A1 through A7, comprising less than or equal to about 0.1 wt % A9-tetrahydrocannabinol.
A9. The composition according to any one of aspects A1 through A8, comprising one or more cannabosides comprising formula IA through XXA:

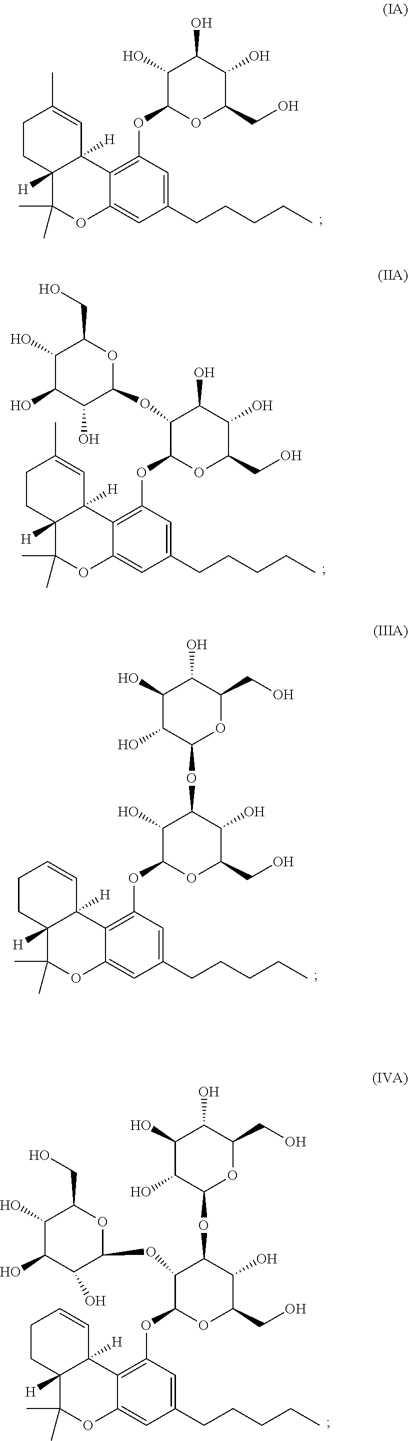

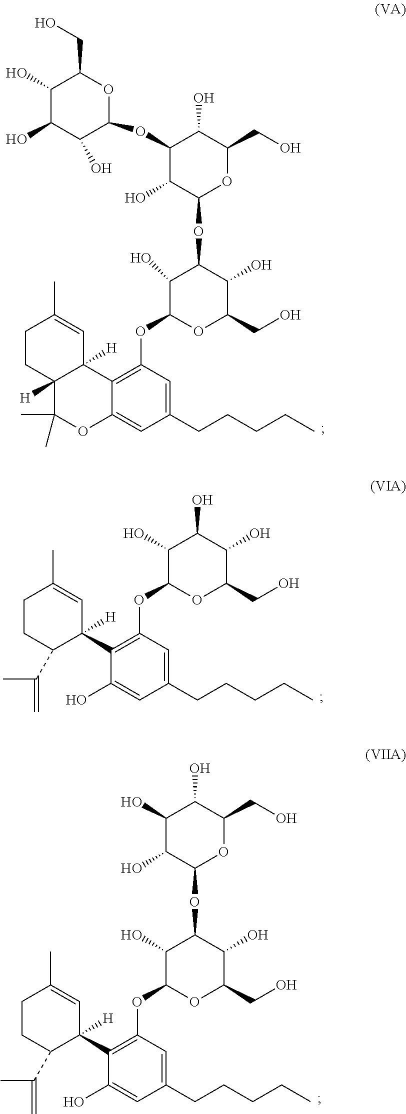

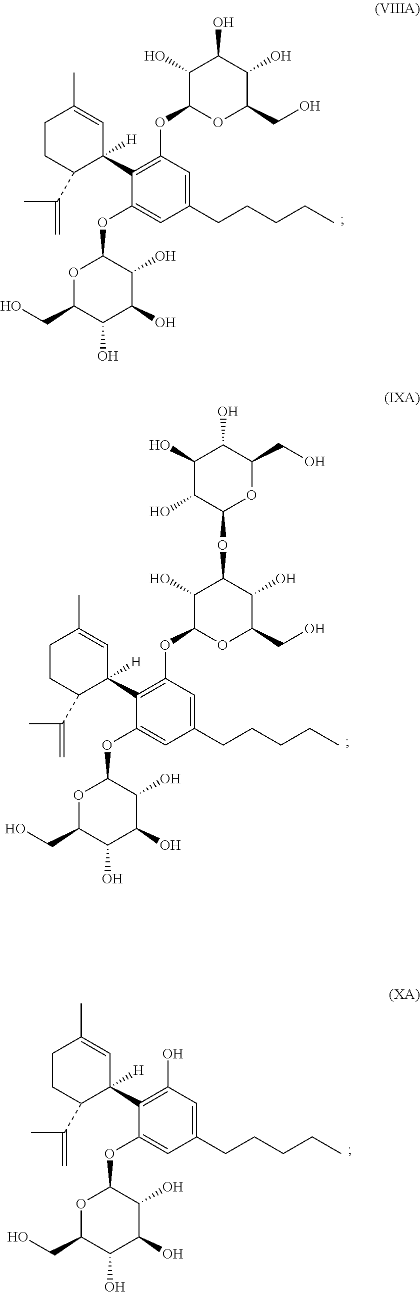 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O)[C@H]1O ; C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O)cc(CCCCC)cc1O[C@@H]1O[C@H](CO)[C@@H](O)[C@H](O)[C@H]1O]

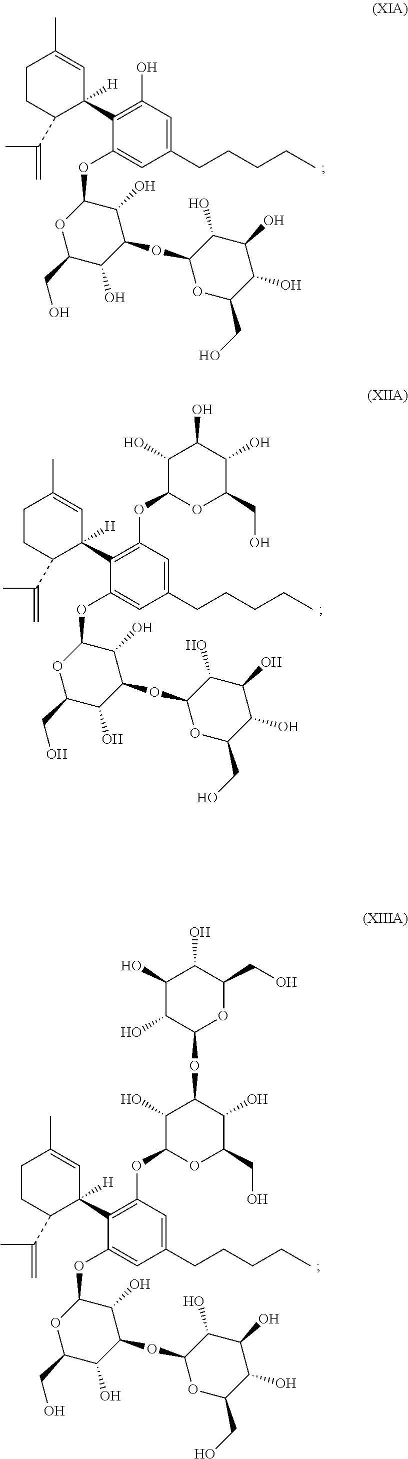

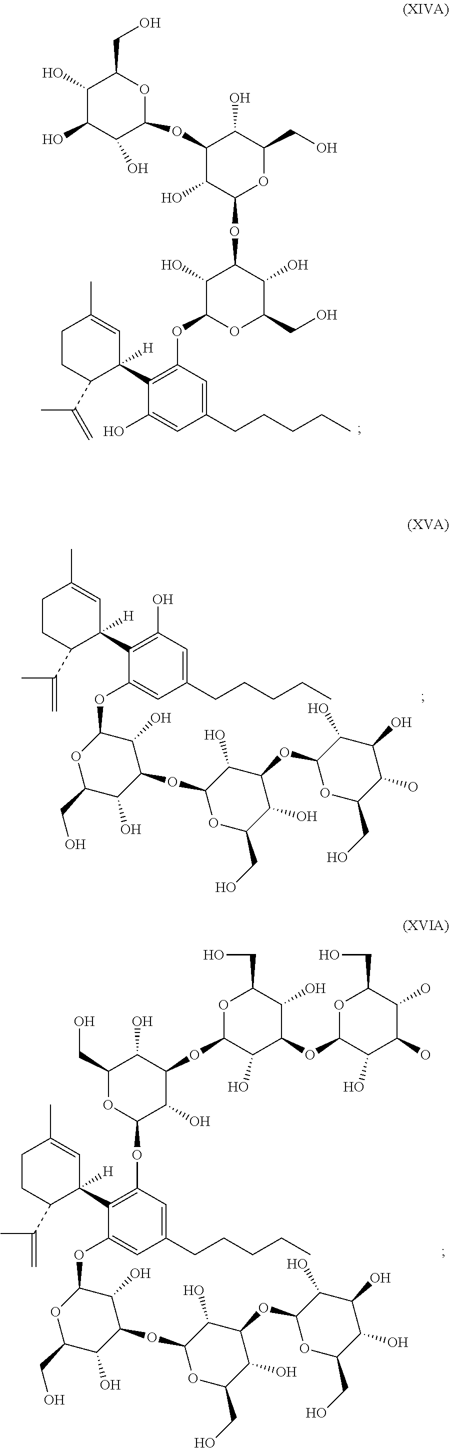

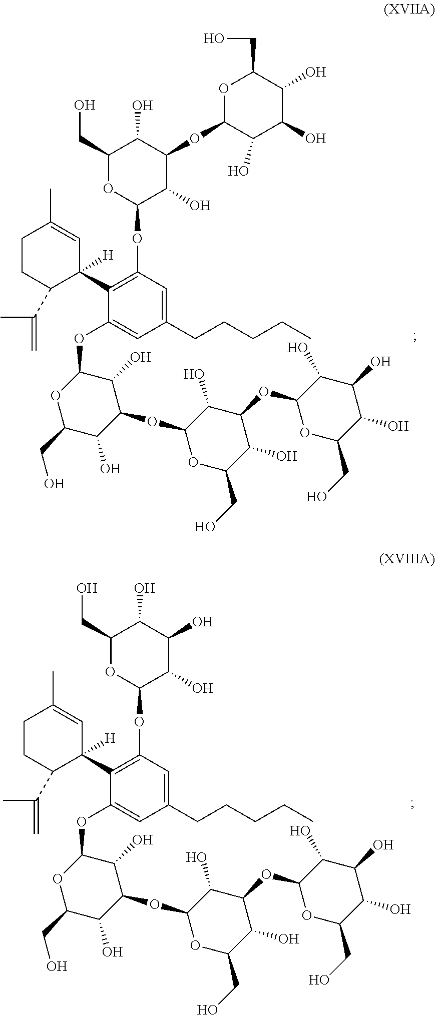 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O ; C=C(C)[C@@H]1CCC(C)=C[C@H]1c1c(O[C@H]2O[C@@H](CO)[C@H](O)[C@@H](O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O]

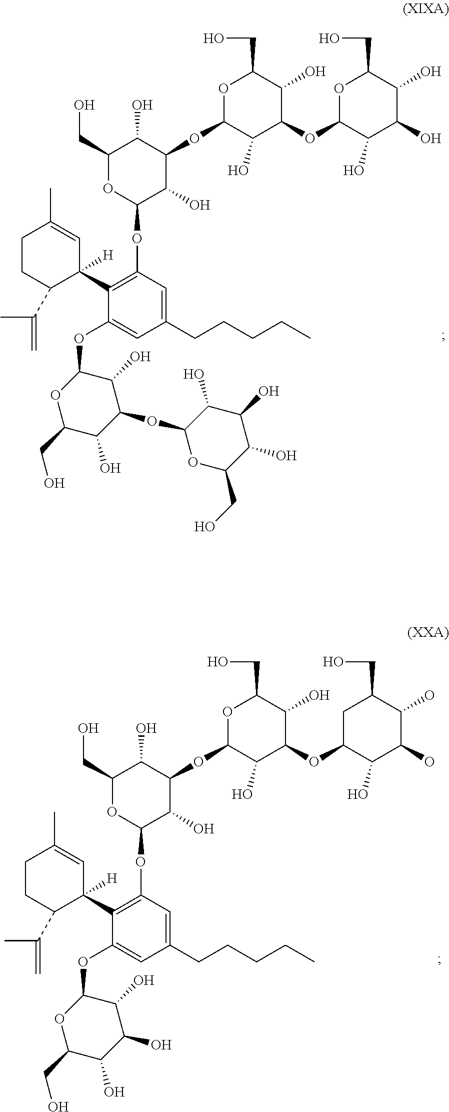 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4C[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O)[C@H]1O]

or a combination thereof.
A10. The composition according to any one of aspects A1 through A9, which is a foodstuff suitable for human consumption.
A11. The composition according to any one of aspects A1 through A10, wherein the foodstuff comprises cricket powder.
A12. The composition according to any one of aspects A1 through A11, wherein a 1 wt % mixture of at least one of the cannabosides and/or the cannabinoid metabolites in water forms a clear solution at 25° C.
A13. The composition according to any one of aspects A1 through A12, comprising greater than or equal to about 10 wt % of the one or more of cannabosides, cannabinoid metabolites, or a combination thereof, based on the total amount of the composition present.
A14. A method comprising:
   feeding an animal a feedstock comprising one or more cannabinoids;
   harvesting the animal; and
   freeze-drying, lyophilizing, dehydrating, and/or masticating at least a portion of the animal to produce a composition according to any one of aspects A1 through A12.
A15. A method comprising:
   feeding an animal a feedstock comprising one or more cannabinoids;
   harvesting the animal; and
   freeze-drying, lyophilizing, dehydrating, and/or masticating at least a portion of the animal to produce a composition comprising one or more cannabosides, cannabinoid metabolites, or a combination thereof produced by the animal.
A16. The method according to aspect A14 or A15, further comprising contacting at least a portion of the harvested animal with a solvent to produce a mixture;
   filtering the mixture, and
   collecting the solvent to produce an extract comprising the one or more cannabosides, cannabinoid metabolites, or a combination thereof.
A17. The method according to aspect A16 further comprising removing at least a portion of the solvent from the extract to form a final extract, wherein a 1 wt % mixture of the final extract in water is a clear solution at 25° C.
A18. The method according to any one of aspects A14 through A17, further comprising feeding the animal a feedstock which does not comprise one or more cannabinoids prior to harvesting.
A19. The method according to any one of aspects A14 through A17, wherein the feedstock comprises one or more tetrahydrocannabinols, cannabidiol, or a combination thereof.
A20. An article comprising:
   a formulation for human ingestion according to any one of aspects A1 through A13.
A21. An article comprising:
   a formulation for human ingestion comprising one or more cannabosides, cannabinoid metabolites, or a combination thereof comprising at least a portion of and/or an extract of an animal which has been fed a feedstock comprising one or more cannabinoids.
A22. The article according to A20 or A21, comprising a beverage pod suitable for use in a single serve beverage brewing machine.

All documents described herein are incorporated by reference herein, including any priority documents and/or testing procedures to the extent they are not inconsistent with this text. As is apparent from the foregoing general description and the specific aspects, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

1. A composition, comprising:
one or more cannabosides, cannabinoid metabolites, or a combination thereof produced by an animal which has been fed a feedstock comprising one or more cannabinoids.

2. The composition of claim 1, comprising at least a portion of the animal which has been fed the feedstock comprising one or more cannabinoids.

3. The composition of claim 2, wherein at least a portion of the animal has been freeze-dried, lyophilized, dehydrated, masticated, or a combination thereof.

4. The composition of claim 1, wherein the one or more cannabosides, cannabinoid metabolites, or a combination thereof present in the composition are produced by extracting at least a portion of the animal which has been fed a feedstock comprising one or more cannabinoids with a solvent.

5. The composition of claim 1, wherein the animal is an insect subject to the proviso that the animal is not a bee.

6. The composition of claim 1, wherein the animal belongs to the Orthoptera order.

7. The composition of claim 1, in the form of a free-flowing solid.

8. The composition of claim 1, comprising less than or equal to about 0.1 wt % A9-tetrahydrocannabinol.

9. The composition of claim 1, comprising one or more cannabosides comprising formula IA through XXA: 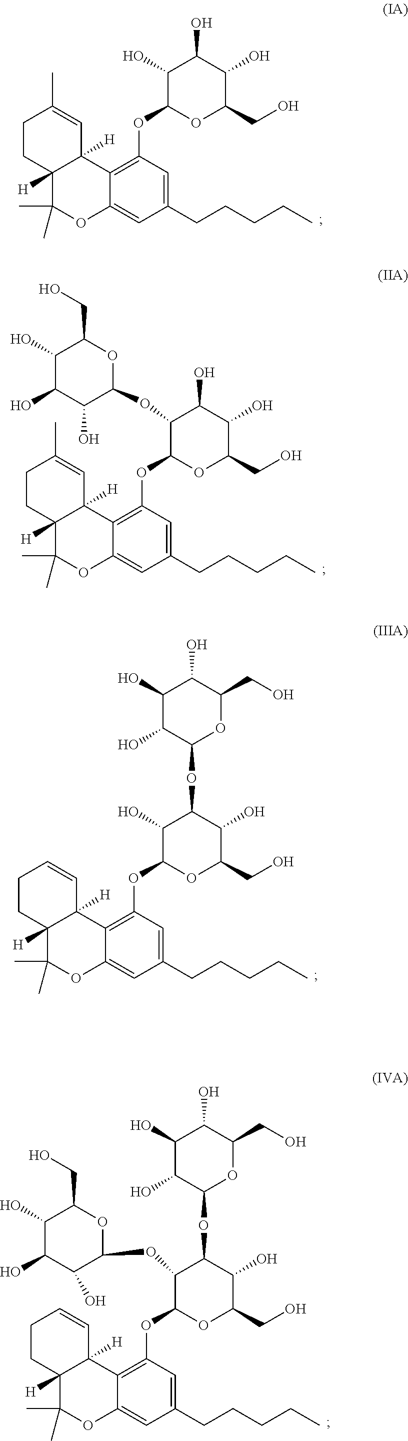 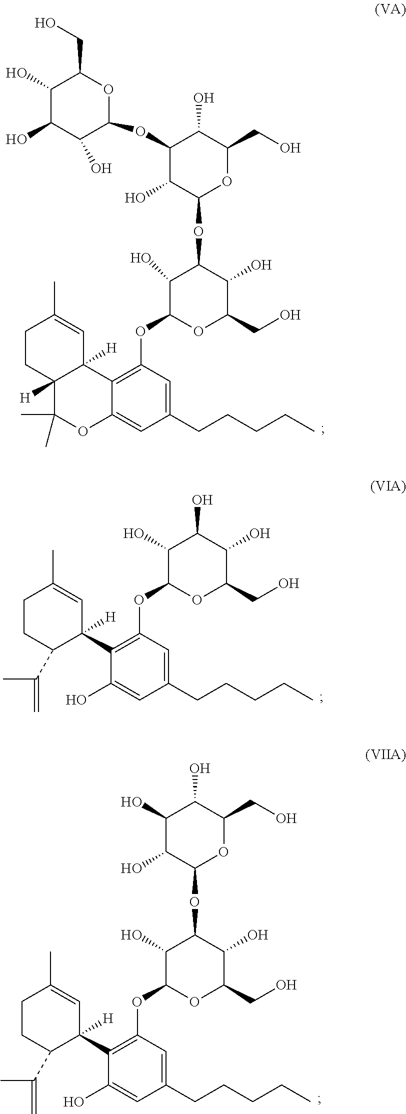 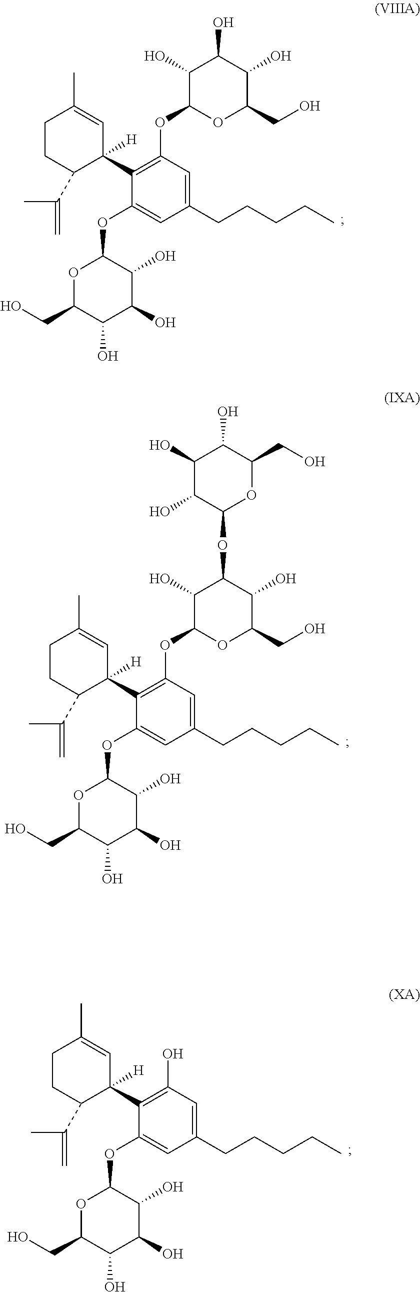 [SMILES: C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O)[C@H]1O ; C=C(C)[C@@H]1CCC(C)=C[C@H]1c1c(O[C@@H]2O[C@H](CO)[C@@H](O)[C@H](O)[C@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O)cc(CCCCC)cc1O[C@@H]1O[C@H](CO)[C@@H](O)[C@H](O)[C@H]1O] 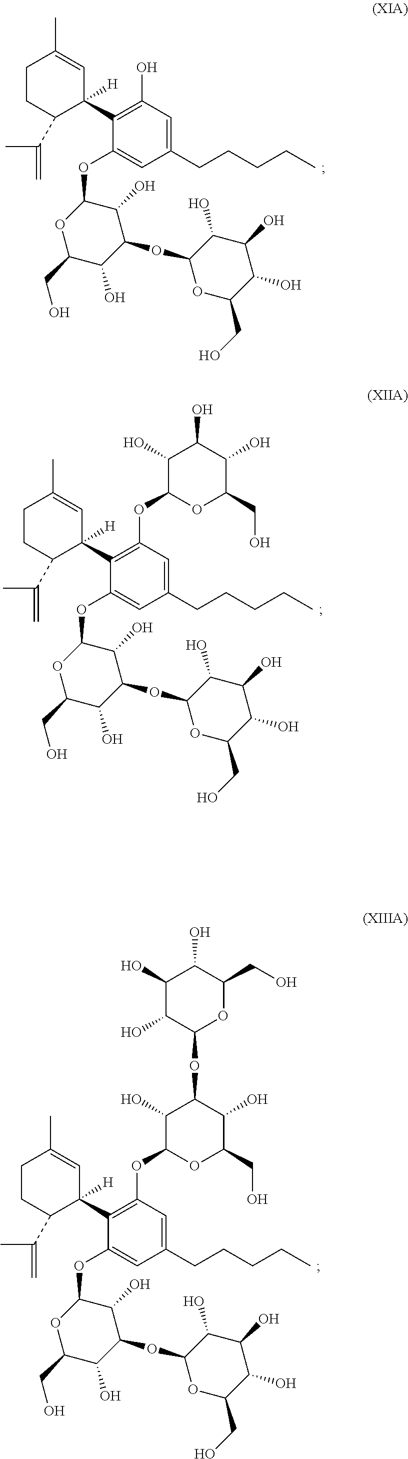 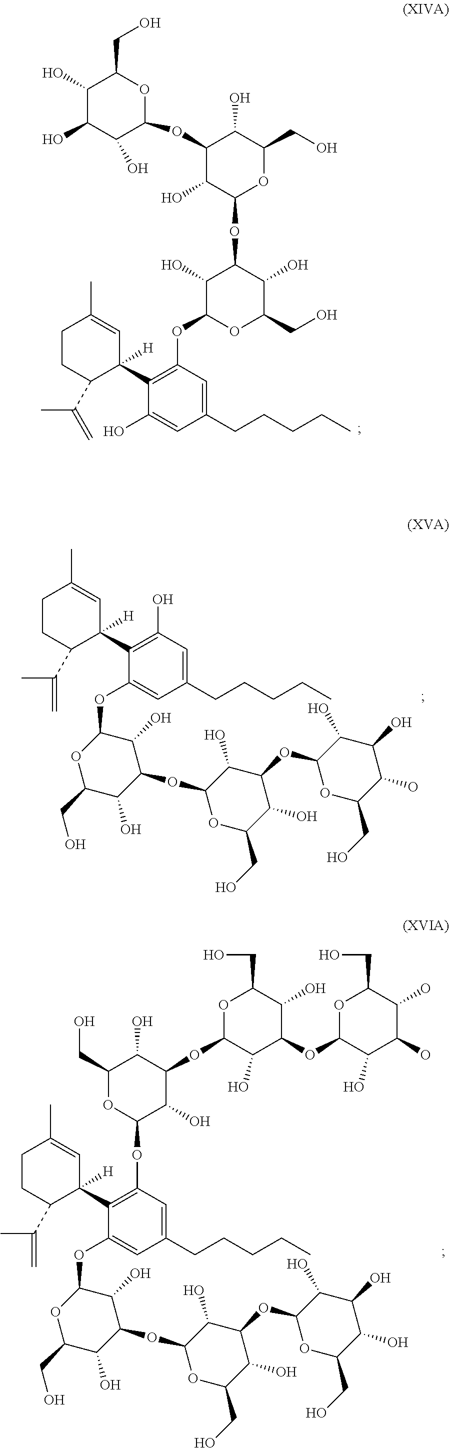 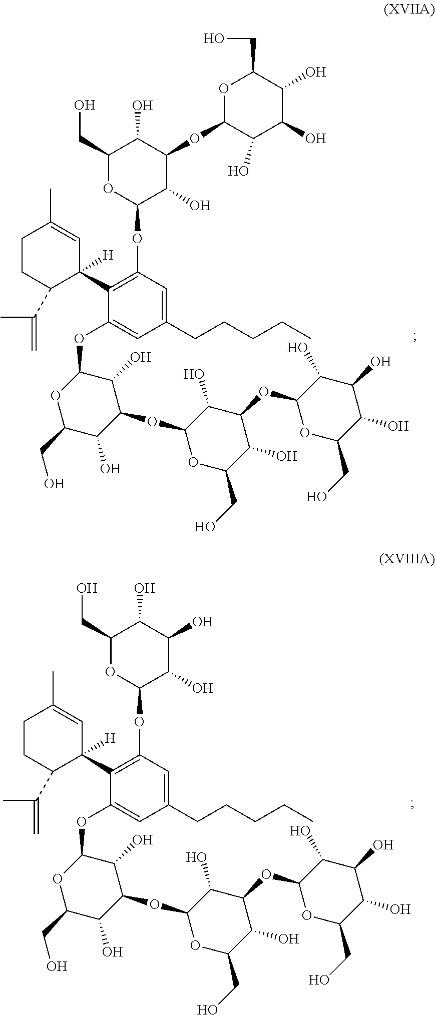 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O ; C=C(C)[C@@H]1CCC(C)=C[C@H]1c1c(O[C@H]2O[C@@H](CO)[C@H](O)[C@@H](O)[C@@H]2O)cc(CCCCC)cc1O[C@@H]1O[C@H](CO)[C@@H](O)[C@H](O[C@@H]2O[C@H](CO)[C@@H](O)[C@H](O[C@@H]3O[C@H](CO)[C@@H](O)[C@H](O)[C@H]3O)[C@H]2O)[C@H]1O] 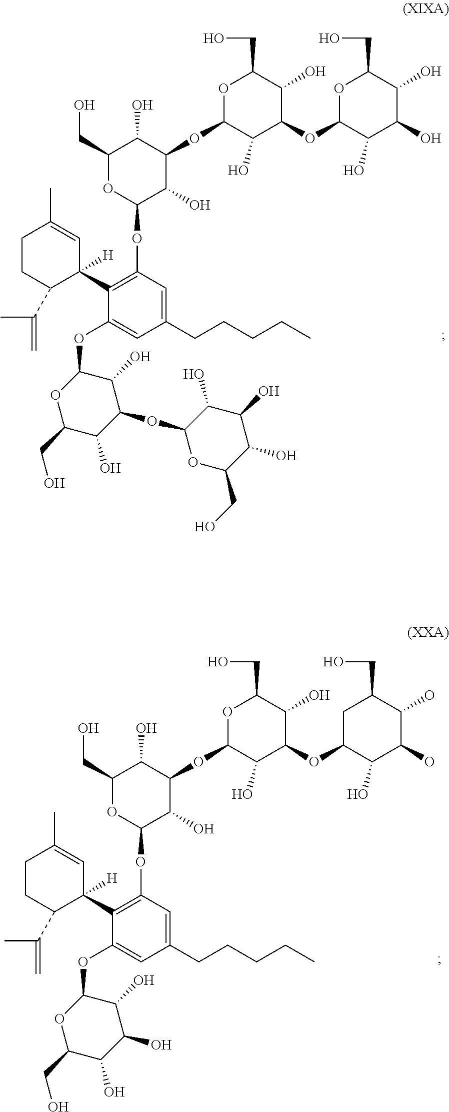 [SMILES: C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4O[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O[C@@H]2O[C@H](CO)[C@@H](O)[C@H](O)[C@H]2O)[C@H]1O ; C=C(C)[C@@H]1CCC(C)=C[C@H]1c1c(O[C@H]2O[C@@H](CO)[C@H](O)[C@@H](O[C@H]3O[C@@H](CO)[C@H](O)[C@@H](O[C@H]4C[C@@H](CO)[C@H](O)[C@@H](O)[C@@H]4O)[C@@H]3O)[C@@H]2O)cc(CCCCC)cc1O[C@@H]1O[C@H](CO)[C@@H](O)[C@H](O)[C@H]1O]
or a combination thereof.

10. The composition of claim 1, which is a foodstuff suitable for human consumption.

11. The composition of claim 10, wherein the foodstuff comprises cricket powder.

12. The composition of claim 1, wherein a 1 wt % mixture of at least one of the cannabosides and/or the cannabinoid metabolites in water forms a clear solution at 25° C.

13. The composition of claim 1, comprising greater than or equal to about 10 wt % of the one or more of cannabosides, cannabinoid metabolites, or a combination thereof, based on the total amount of the composition present.

14. A method comprising:
feeding an animal a feedstock comprising one or more cannabinoids;
harvesting the animal; and
freeze-drying, lyophilizing, dehydrating, and/or masticating at least a portion of the animal to produce a composition comprising one or more cannabosides, cannabinoid metabolites, or a combination thereof produced by the animal.

15. The method of claim 14, further comprising contacting at least a portion of the harvested animal with a solvent to produce a mixture;
filtering the mixture, and
collecting the solvent to produce an extract comprising the one or more cannabosides, cannabinoid metabolites, or a combination thereof.

16. The process of claim 15, further comprising removing at least a portion of the solvent from the extract to form a final extract, wherein a 1 wt % mixture of the final extract in water is a clear solution at 25° C.

17. The method of claim 14, further comprising feeding the animal a feedstock which does not comprise one or more cannabinoids prior to harvesting.

18. The method of claim 14, wherein the feedstock comprises one or more tetrahydrocannabinols, cannabidiol, or a combination thereof.

19. An article comprising:
a formulation for human ingestion comprising one or more cannabosides, cannabinoid metabolites, or a combination thereof comprising at least a portion of and/or an extract of an animal which has been fed a feedstock comprising one or more cannabinoids.

20. The article of claim 19, comprising a beverage pod suitable for use in a single serve beverage brewing machine.
